(19) United States
(12) Patent Application Publication
(10) Pub. No.: US 2024/0338009 A1
(43) Pub. Date: Oct. 10, 2024

(54) INFORMATION PROCESSING APPARATUS, SHAPING SYSTEM, INFORMATION PROCESSING METHOD, METHOD FOR MANUFACTURING SHAPED OBJECT, AND RECORDING MEDIUM

(71) Applicant: CANON KABUSHIKI KAISHA, Tokyo (JP)

(72) Inventors: TAKUYA SHIMIZU, Kanagawa (JP); KENJI MATSUDA, Kanagawa (JP)

(21) Appl. No.: 18/621,447

(22) Filed: Mar. 29, 2024

(30) Foreign Application Priority Data
Apr. 7, 2023 (JP) 2023-062787

(51) Int. Cl. G05B 19/4099; B22F 10/28; B22F 10/85; B29C 64/124; B29C 64/153; B29C 64/264; B29C 64/393; B33Y 10/00; B33Y 30/00; B33Y 50/02

(52) U.S. Cl. CPC G05B 19/4099; B22F 10/85; B29C 64/264; B29C 64/393; B33Y 30/00; B33Y 50/02; B22F 10/28; B29C 64/124; B29C 64/153; B33Y 10/00; G05B 2219/49023

(57) ABSTRACT

An information processing apparatus includes an information processing portion configured to obtain setting information set for a shaping apparatus for causing the shaping apparatus to form a plurality of layers. The plurality of layers include an (n−1)-th layer, and an n-th layer formed subsequently to the (n−1)-th layer. The n-th layer includes a first region overlapping with the (n−1)-th layer in a lamination direction, and a second region that is continuous with the first region and that does not overlap with the (n−1)-th layer in the lamination direction. The setting information includes information for setting an energy radiated by an irradiation portion of the shaping apparatus in formation of the first region to first intensity, and information for setting the energy radiated by the irradiation portion in formation of the second region to second intensity lower than the first intensity.

### BACKGROUND OF THE INVENTION

### Field of the Invention

The present disclosure relates to a technique of forming a shaped object.

### Description of the Related Art

As a means for manufacturing a wide variety of parts in small lots, manufacturing a shaped object by a shaping method such as a powder sintering method or an optical shaping method is known. Known examples of the shaping method include a stereolithography apparatus (SLA) method in which ultraviolet laser light is moved in a scanning manner by using a galvano mirror device for selective curing, a digital light processing (DLP) method in which a surface is exposed to light by reflecting ultraviolet light by a large number of digital micromirror devices (DMDs), and a liquid crystal display (LCD) method in which a desired shape is obtained by surface exposure by controlling transmission of ultraviolet light by using a liquid crystal display.

Japanese Patent Laid-Open No. H07-125079 discloses a method of forming a shaped object having an overhang portion. Japanese Patent Laid-Open No. H07-125079 discloses correcting three-dimensional shape data or contour data for layer formation.

However, even if the shaped object is formed by the method described in Japanese Patent Laid-Open No. H07-125079, an excess shaped portion of a shape different from a designed shape can be formed on the overhang portion. In recent years, the demand for higher dimensional precision has increased, and it is preferred that the size of the excess shaped portion is as small as possible.

### SUMMARY OF THE INVENTION

According to a first aspect of the present disclosure, an information processing apparatus is used for a shaping apparatus configured to form a shaped object including a plurality of layers laminated on each other. The information processing apparatus includes an information processing portion. The information processing portion is configured to obtain setting information set for the shaping apparatus for causing the shaping apparatus to form the plurality of layers. The plurality of layers include an (n−1)-th layer (n is an integer of 2 or more), and an n-th layer formed subsequently to the (n−1)-th layer. The n-th layer includes a first region overlapping with the (n−1)-th layer in a lamination direction, and a second region that is continuous with the first region and that does not overlap with the (n−1)-th layer in the lamination direction. The setting information includes information for setting an energy radiated by an irradiation portion of the shaping apparatus in formation of the first region to first intensity, and information for setting the energy radiated by the irradiation portion in formation of the second region to second intensity lower than the first intensity.

According to a second aspect of the present disclosure, an information processing method is a method for an information processing apparatus used for a shaping apparatus configured to form a shaped object including a plurality of layers laminated on each other. The information processing method includes obtaining setting information set for the shaping apparatus for causing the shaping apparatus to form the plurality of layers. The plurality of layers include an (n−1)-th layer (n is an integer of 2 or more), and an n-th layer formed subsequently to the (n−1)-th layer. The n-th layer includes a first region overlapping with the (n−1)-th layer in a lamination direction, and a second region that is continuous with the first region and that does not overlap with the (n−1)-th layer in the lamination direction. The setting information includes information for setting an energy radiated by an irradiation portion of the shaping apparatus in formation of the first region to first intensity, and information for setting the energy radiated by the irradiation portion in formation of the second region to second intensity lower than the first intensity.

Further features of the present invention will become apparent from the following description of exemplary embodiments with reference to the attached drawings.

### BRIEF DESCRIPTION OF THE DRAWINGS

FIG. 1 is a schematic view of a shaping system according to a first embodiment.

FIG. 2 is a block diagram illustrating a configuration of a control system of the shaping system according to the first embodiment.

FIG. 3 is an explanatory diagram of a case where a shaped object is manufactured by a manufacturing method of a comparative example.

FIG. 4 is a flowchart illustrating information processing according to the first embodiment.

FIG. 5 is an explanatory diagram of the information processing according to the first embodiment.

FIG. 6A is an explanatory diagram of the information processing according to the first embodiment.

FIG. 6B is an explanatory diagram of the information processing according to the first embodiment.

FIG. 6C is an explanatory diagram of the information processing according to the first embodiment.

FIG. 7A is an explanatory diagram of the information processing according to the first embodiment.

FIG. 7B is an explanatory diagram of the information processing according to the first embodiment.

FIG. 7C is an explanatory diagram of the information processing according to the first embodiment.

FIG. 8A is a graph illustrating a relationship between a gradation value in a grayscale and light intensity according to the first embodiment.

FIG. 8B is a graph illustrating a relationship between an overhang distance and a gradation value according to the first embodiment.

FIG. 9 is a flowchart of a manufacturing method for the shaped object according to the first embodiment.

FIG. 10 is a schematic view of a shaped object according to a second embodiment.

FIG. 11A is an explanatory diagram of information processing according to the second embodiment.

FIG. 11B is an explanatory diagram of the information processing according to the second embodiment.

FIG. 11C is an explanatory diagram of the information processing according to the second embodiment.

FIG. 12A is an explanatory diagram of the information processing according to the second embodiment.

FIG. 12B is an explanatory diagram of the information processing according to the second embodiment.

FIG. 13A is an explanatory diagram of the information processing according to the second embodiment.

FIG. 13B is an explanatory diagram of the information processing according to the second embodiment.

FIG. 14 is a schematic view of a shaped object according to a third embodiment.

FIG. 15A is an explanatory diagram of information processing according to the third embodiment.

FIG. 15B is an explanatory diagram of the information processing according to the third embodiment.

FIG. 15C is an explanatory diagram of the information processing according to the third embodiment.

FIG. 16A is an explanatory diagram of the information processing according to the third embodiment.

FIG. 16B is an explanatory diagram of the information processing according to the third embodiment.

FIG. 16C is an explanatory diagram of the information processing according to the third embodiment.

FIG. 17A is a perspective view of a shaped object according to Example 1.

FIG. 17B is a section view of the shaped object according to Example 1.

FIG. 18A is a perspective view of a shaped object according to Example 2.

FIG. 18B is a section view of the shaped object according to Example 2.

FIG. 19 is a diagram illustrating experimental results of Examples 1 to 3 and Comparative Example 1.

### DESCRIPTION OF THE EMBODIMENTS

Exemplary embodiments of the present disclosure will be described below with reference to drawings.

### First Embodiment

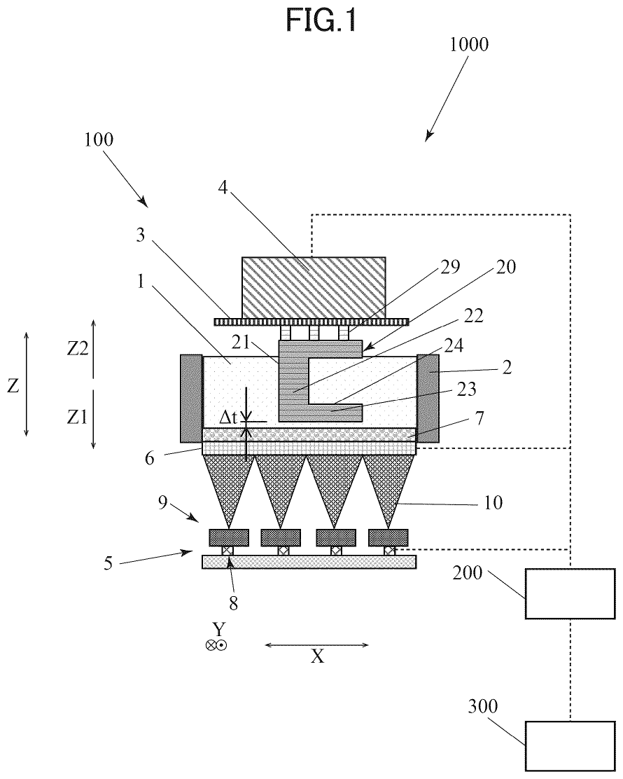

FIG. 1 is a schematic view of a shaping system 1000 according to a first embodiment. The shaping system 1000 is a so-called 3D printer. The shaping system 1000 is a system that forms a shaped object 20 by an optical shaping method, that is, a system that forms the shaped object 20 by laminating a plurality of cured layers obtained by curing a photocurable resin composition 1. In the description below, the cured layers will be also simply referred to as “layers”. In the first embodiment, the shaping material used for forming the shaped object 20 is the photocurable resin composition 1. In addition, the optical shaping method according to the first embodiment is the LCD method.

The shaped object 20 is a cured product of the photocurable resin composition 1. The shaped object 20 includes a shaped product 21 and supports 29 supporting the shaped product 21. The shaped product 21 has a base portion 22 and an overhang portion 23 projecting in an X direction from the base portion 22. The overhang portion 23 is a part not overlapping with the base portion 22 in a Z direction. Here, the X direction, a Y direction, and the Z direction are orthogonal to each other. The X direction and the Y direction are horizontal directions, and the Z direction is an up-down direction, that is, the vertical direction. A Z1 direction is a downward direction, and a Z2 direction is an upward direction. The Z2 direction is opposite to the Z1 direction.

The shaping system 1000 includes a shaping apparatus 100 that forms the shaped object 20, and an information processing apparatus 300 used by the shaping apparatus 100. The shaping apparatus 100 includes a container 2, a shaping stage 3, a lifting apparatus 4, a light irradiation portion 5, and a control apparatus 200. The information processing apparatus 300 generates setting information (data) to be set in the shaping apparatus 100, and outputs the setting information to the control apparatus 200 of the shaping apparatus 100. The control apparatus 200 obtains the setting information from the information processing apparatus 300, and controls the lifting apparatus 4, the light irradiation portion 5, and the like in accordance with the setting information. As a result of this, the shaping apparatus 100 manufactures the shaped object 20.

A lower portion of the container 2 is a releasing transmitting film 7 capable of transmitting light. The photocurable resin composition 1 is reserved in the container 2. The photocurable resin composition 1 reserved in the container 2 is uncured photocurable resin composition in a liquid form. The photocurable resin composition 1 is, for example, a UV-curable resin composition. The photocurable resin composition 1 is, for example, radically polymerizable. As a radically-polymerizable photocurable resin composition, for example, an acrylate-based resin composition can be selected. In particular, as acrylate-based oligomers, urethan acrylate-based, epoxy acrylate-based, polyester acrylate-based, acryl acrylate-based oligomers, and the like can be selected. The photocurable resin composition 1 may contain a reinforcing agent such as an inorganic filler for improving the mechanical strength.

The light irradiation portion 5 is an example of an irradiation portion, and radiates an energy of intensity required for shaping the photocurable resin composition 1 onto the photocurable resin composition 1 reserved in the container 2. The energy is, for example, light 10 in the first embodiment. The intensity of the energy is the intensity of the light 10. The light irradiation portion 5 is configured to radiate the light 10 for curing the photocurable resin composition 1 in the Z2 direction toward the shaping stage 3 from below the container 2 through the releasing transmitting film 7. The Z2 direction also serves as the irradiation direction of the light 10.

The shaping stage 3 functions as a base for supporting a cured object obtained by curing the photocurable resin composition 1 by the light irradiation by the light irradiation portion 5. The shaping stage 3 can be disposed in the container 2 so as to be movable in the Z direction. The shaping stage 3 is driven in the Z direction by the lifting apparatus 4. The lifting apparatus 4 lifts and lowers the shaping stage 3 in the Z direction in accordance with an input command.

After formation of one cured layer is completed, the shaping stage 3 is moved in the Z2 direction by the lifting apparatus 4 so as to form the next cured layer on the cured layer. In accordance with the movement of the shaping stage 3, the photocurable resin composition 1 for forming the next cured layer on a lower portion of the cured object is supplied onto the upper surface of the releasing transmitting film 7. Then, the light 10 is radiated for forming the next cured layer. In this manner, the next cured layer is formed on the already-formed cured layer. In the first embodiment, the lamination direction of the cured layer is a direction relatively downward with respect to the shaping stage 3, that is, the Z1 direction.

The light irradiation portion 5 includes a light source 8, a lens unit 9, and a liquid crystal display 6. For example, the light source 8 includes a plurality of light emitting diodes (LEDs). The lens unit 9 includes a plurality of lenses. The lens unit 9 radiates the light 10 emitted from the light source 8 onto the liquid crystal display 6 such that the intensity is uniform in the plane of the liquid crystal display 6.

The liquid crystal display 6 is disposed on the light incident side of the releasing transmitting film 7, that is, below the releasing transmitting film 7. The distance between the liquid crystal display 6 and the releasing transmitting film 7 is preferably small. The liquid crystal display 6 is a liquid crystal display of a light transmission type including a plurality of pixels arranged in the X direction and the Y direction. The liquid crystal display 6 is capable of adjusting the intensity of transmitted light for each pixel. As a result of adjusting the gradation value, that is, the light transmittance of each pixel, the intensity of light transmitted through each pixel is adjusted. In the first embodiment, the light transmittance of each pixel is independently adjusted in a 256-level grayscale, and thus the intensity of light transmitted through each pixel is adjusted in 256 levels. To be noted, the number of gradations is not limited to 256 as long as a grayscale is expressed.

The wavelength of the light 10 emitted from the light source 8 may be of any value as long as the wavelength is suitable for the polymerization reaction of the photocurable resin composition 1. For example, if the photocurable resin composition 1 is UV-curable, the light 10 emitted from the light source 8 is ultraviolet light, for example, light of a wavelength selected from a range of about 200 nm to 400 nm. The wavelength of the light 10 emitted from the light source 8 is typically 405 nm or 365 nm. To be noted, the light 10 emitted from the light source 8 is not limited to ultraviolet light, and may be any light as long as the wavelength of the light is appropriate for the material of the photocurable resin composition 1.

The light 10 emitted from the light source 8 is radiated in the Z2 direction at uniform intensity in the plane of the liquid crystal display 6 by the lens unit 9. Further, the transmittance of the light 10 radiated to the liquid crystal display 6 is adjusted for each pixel of the liquid crystal display 6. The light 10 transmitted through the liquid crystal display 6 in the Z2 direction is transmitted through the releasing transmitting film 7, and thus a cured layer of one layer having a thickness Δt is formed on the shaping stage 3 or on a cured layer formed on the shaping stage 3. Then, the shaping stage 3 is lifted in the Z2 direction by an amount corresponding to one layer. The operation described above is repeated, and thus a plurality of cured layers laminated in the Z1 direction are formed on the shaping stage 3. That is, the shaped object 20 that has been formed includes a plurality of layers laminated in the Z1 direction. The overhang portion 23 has an overhang surface 24 facing the photocurable resin composition 1 in the Z2 direction in the shaping process. The overhang surface 24 is a surface of the overhang portion 23 on the downstream side in the Z2 direction. The overhang surface 24 is a surface projecting in the X direction from the base portion 22.

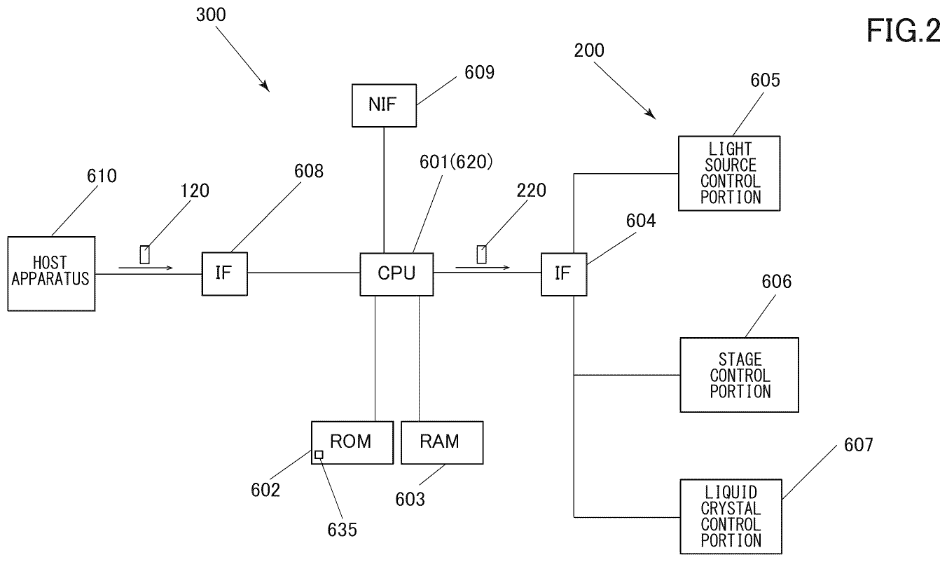

FIG. 2 is a block diagram illustrating a configuration of a control system of the shaping system 1000 according to the first embodiment. The shaping system 1000 includes the control apparatus 200 and the information processing apparatus 300. The information processing apparatus 300 is connected to a host apparatus 610. The control apparatus 200 includes a light source control portion 605, a stage control portion 606, and a liquid crystal control portion 607. The host apparatus 610 and the information processing apparatus 300 are each constituted by a computer.

The host apparatus 610 generates a three-dimensional shape model 120 corresponding to the shaped object 20. The three-dimensional shape model 120 includes three-dimensional shape data such as computer-aided design (CAD) data. The information processing apparatus 300 obtains the three-dimensional shape model 120 from the host apparatus 610, generates setting information 220 used for the formation of the shaped object 20 on the basis of the three-dimensional shape model 120, and transmits the setting information 220 to the respective portions 605 to 607 of the control apparatus 200. The setting information 220 is also a control command of instruction to the respective portions 605 to 607.

The light source control portion 605 controls the light source 8 in accordance with the control command obtained from the information processing apparatus 300. The stage control portion 606 controls the lifting apparatus 4 that drives the shaping stage 3 in accordance with the control command obtained from the information processing apparatus 300. The liquid crystal control portion 607 controls the light transmittance of each pixel of the liquid crystal display 6 in accordance with the control command obtained from the information processing apparatus 300.

The information processing apparatus 300 includes a central processing unit (CPU) 601 serving as an example of a processor, and a read-only memory (ROM) 602 and a random access memory (RAM) 603 serving as examples of storage devices, and IFs 604 and 608 that are input/output interfaces, and an NIF 609 that is a network interface. The CPU 601, the ROM 602, the RAM 603, the IFs 604 and 608, and the NIF 609 are interconnected via a bus such that data can be communicated therebetween.

The CPU 601 functions as an information processing portion 620 that executes an information processing method that will be described later, by executing a program 635. The CPU 601 obtains the three-dimensional shape model 120 of the shaped object 20 from the host apparatus 610 via the IF 608.

The ROM 602 stores the program 635 that can be executed by the CPU 601. That is, the ROM 602 constitutes a computer-readable non-transitory recording medium storing the program 635. The ROM 602 may be a rewritable storage device such as an erasable programmable ROM (EPROM) or an electrically erasable programmable ROM (EEPROM). In addition, the information processing apparatus 300 may include a storage such as a hard disk drive (HDD) or a solid state device (SSD) capable of storing the program 635.

To be noted, the program 635 to be executed by the CPU 601 is not limited to a case where the program 635 is stored in a recording medium included in a computer such as the ROM 602. The program 635 may be stored in a storage device or a recording disk that can be supplied to the computer, as long as the storage device or the recording disk is a non-transitory computer-readable recording medium. Examples of the recording disk include optical disks and magnetic disks. In addition, examples of the storage device include flash memories externally attached to the information processing apparatus 300 such as a universal serial bus (USB) memory. In addition, the program 635 may be downloaded to the computer from a network via the NIF 609.

The IFs 604 and 608 and the NIF 609 can be configured on the basis of, for example, a serial interface standard or a parallel interface standard.

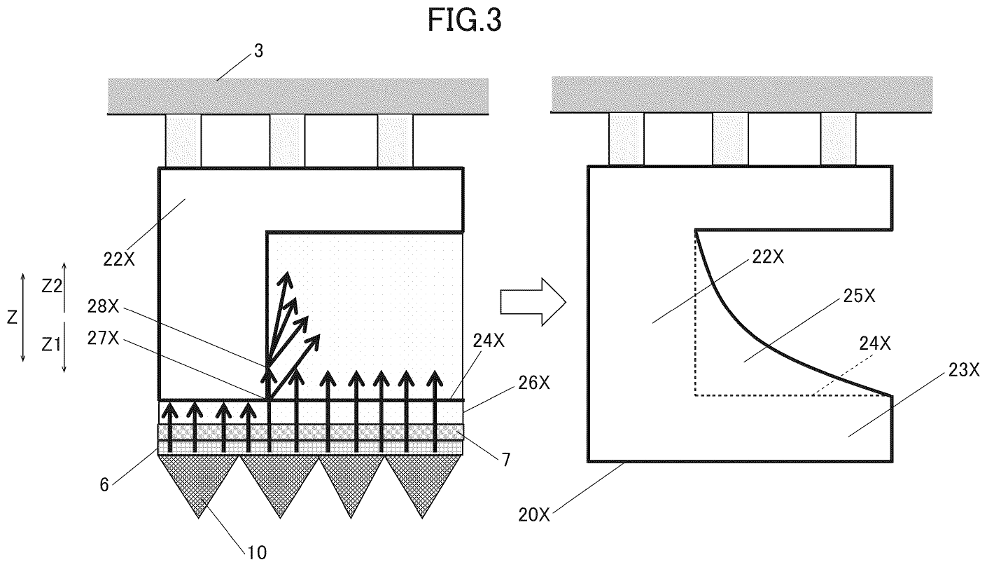

Here, a case of manufacturing a shaped object by a manufacturing method of a comparative example will be described. FIG. 3 is an explanatory diagram of a case where a shaped object 20X is manufactured by the manufacturing method of the comparative example. A shaping apparatus in the comparative example is the same as the shaping apparatus 100 of the first embodiment, but the control of the liquid crystal display 6 is different from the first embodiment. The shaped object 20X has a base portion 22X, and an overhang portion 23X projecting in the X direction from the base portion 22X.

In the comparative example, the light 10 passing through the liquid crystal display 6 is radiated also in a region for forming the overhang portion 23X at a uniform intensity that is the same as in a region for forming the base portion 22X, for example, at an intensity of 2.8 mW/cm². In the case of forming a shaped layer 26X having an overhang surface 24X of the overhang portion 23X, the light 10 is transmitted to a position higher than the shaped layer 26X, and thus the photocurable resin composition 1 that is higher than the overhang surface 24X can be unintentionally cured. Particularly, in a region of the overhang surface 24X close to the base portion 22X, as a result of diffused reflection of light at a corner portion 27X or a solid wall 28X of an already-formed portion of the base portion 22X on the overhang surface 24X side, the photocurable resin composition 1 is cured deeply in the Z2 direction. Therefore, an excess shaped portion 25X having a curved shape whose thickness in the Z direction is smaller at a portion farther from the base portion 22X in the X direction is formed above the overhang portion 23X.

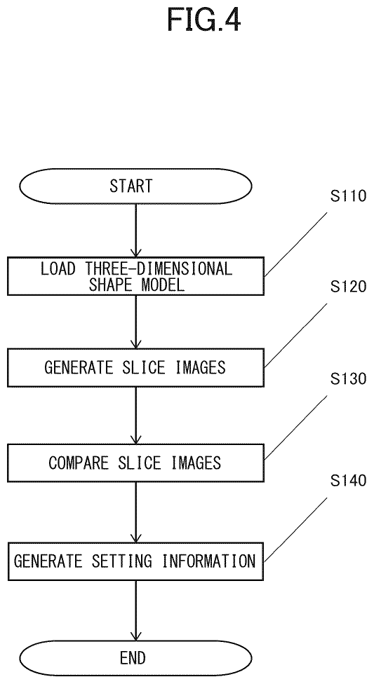

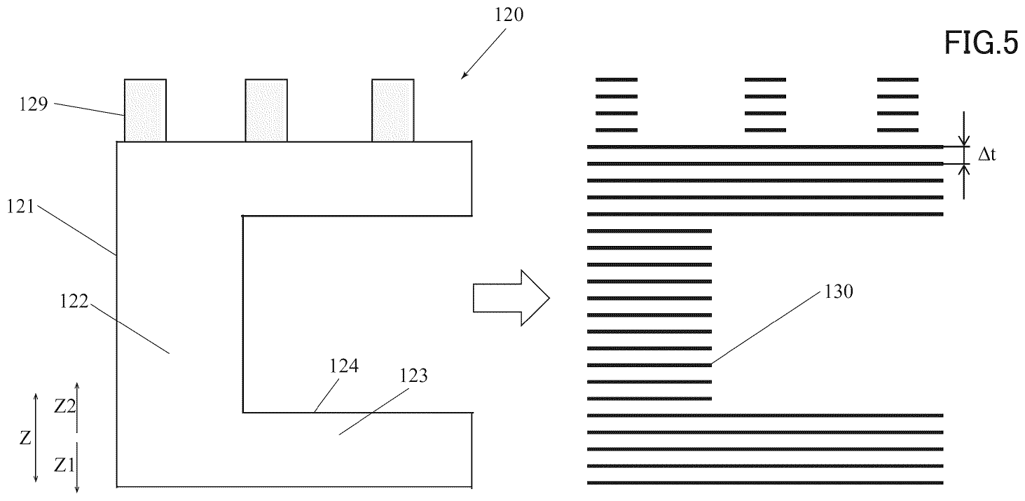

FIG. 4 is a flowchart illustrating information processing according to the first embodiment. FIG. 5 is an explanatory diagram of information processing according to the first embodiment.

In step S110, the information processing portion 620 loads, for example, the three-dimensional shape model 120 corresponding to the shaped object 20 generated by using 3DCAD software. The three-dimensional shape model 120 includes a portion 121 corresponding to the shaped product 21 and a portion 129 corresponding to the supports 29 to be detached from the shaped product 21. The portion 121 corresponding to the shaped product 21 includes a portion 122 corresponding to the base portion 22 and a portion 123 corresponding to the overhang portion 23. The portion 123 corresponding to the overhang portion 23 includes a portion 124 corresponding to the overhang surface 24 of the overhang portion 23. To be noted, the three-dimensional shape model 120 may be generated by the information processing portion 620.

Next, in step S120, the information processing portion 620 generates a plurality of slice images 130 obtained by slicing the three-dimensional shape model 120 to a predetermined thickness Δt. Each slice image 130 corresponds to a layer in the shaped object 20. To be noted, the slice images 130 may be generated by a different computer such as the host apparatus 610 or input to the information processing portion 620 instead of being generated by the information processing portion 620.

In step S130, the information processing portion 620 compares two adjacent slice images in the plurality of slice images 130. Then, in step S140, the information processing portion 620 generates setting information 220 on the basis of the result of comparison. That is, the information processing portion 620 obtains the setting information 220.

Here, the setting information 220 is information set in the shaping apparatus 100 to cause the shaping apparatus 100 to form the plurality of layers. In the first embodiment, the shaping apparatus 100 includes the liquid crystal display 6, and therefore the setting information includes information for setting the light transmittance (intensity) of each pixel of the liquid crystal display 6, for example, a grayscale image, for each of the plurality of layers. The light transmittance, that is, the intensity of transmitted light can be expressed in a grayscale.

The grayscale is numerical expression of brightness/darkness of the transmitted light in a range from white (bright) indicating a state in which the light intensity is the highest to black (dark) indicating a state in which the light intensity is the lowest. On the liquid crystal display 6, a grayscale image including while, black, and gray between white and black is displayed. For example, in the case where the numerical value is expressed by 8 bits, the light transmittance, that is, the light intensity is adjusted in 256 gradation levels at gradation values of 0 to 255 in each pixel of the liquid crystal display 6. That is, the setting information 220 includes 8-bit numerical information from 0 to 255 assigned to each pixel. The liquid crystal control portion 607 can control the light transmittance of each pixel of the liquid crystal display 6 in accordance with the numerical information included in the control command.

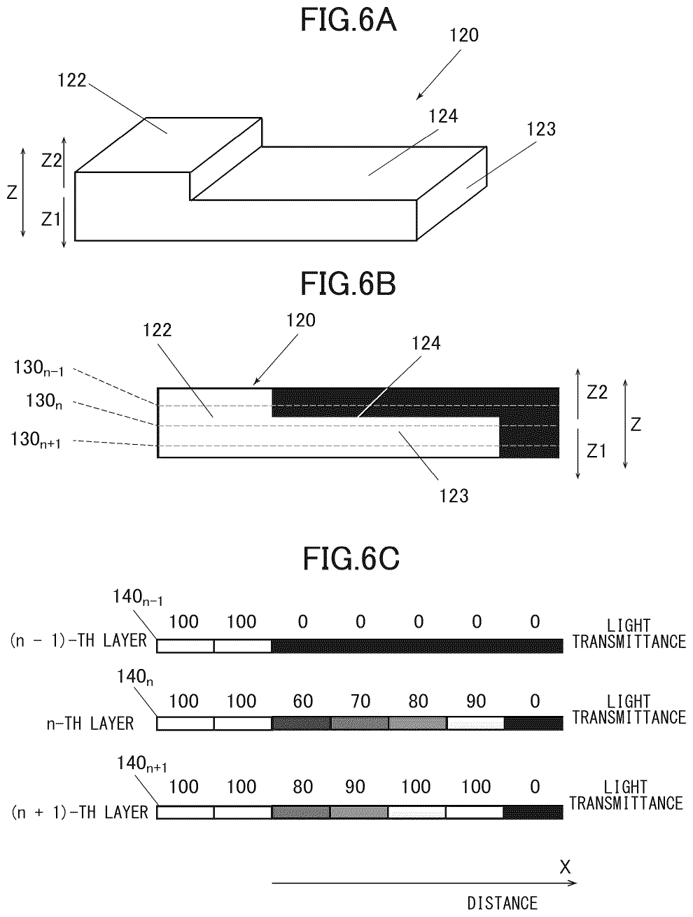

FIGS. 6A to 6C are each an explanatory diagram of the information processing according to the first embodiment. FIG. 6A is a perspective view schematically illustrating part of the three-dimensional shape model 120 corresponding to the shaped object 20 as a three-dimensional image. The information processing portion 620 slices the three-dimensional shape model 120 illustrated in FIG. 6A, and thus obtains slice images 130ₙ₋₁, 130ₙ, 130ₙ₊₁ illustrated in FIG. 6B, where n is an integer of 2 or more.

The slice image 130ₙ₋₁ is slice data including the portion 122 corresponding to the base portion 22. The slice image 130ₙ is slice data including the portion 122 corresponding to the base portion 22 and the portion 123 corresponding to the overhang portion 23. The slice image 130ₙ₊₁ is slice data including the portion 122 corresponding to the base portion 22 and the portion 123 corresponding to the overhang portion 23.

Here, the plurality of layers of the shaped object 20 are formed in the order of the first layer to the M-th layer in the Z1 direction. The first layer is a layer formed on the shaping stage 3. M is an integer of 3 or more, and n is an integer of 2 or more (M−1). For example, in the case of M=100, n is an integer of 2 or more and 99 or less. In addition, for example, in the case of n=2, the (n−1)-th layer is the first layer, the n-th layer is the second layer, and the (n+1)-th layer is the third layer. In addition, for example, in the case of n=99, the (n−1)-th layer is the 98th layer, the n-th layer is the 99th layer, and the (n+1)-th layer is the 100th layer. After the (n−1)-th layer is formed, the n-th layer is formed next on the (n−1)-th layer, and then the (n+1)-th layer is formed on the n-th layer.

The slice image 130ₙ₋₁ is a slice image corresponding to the (n−1)-th layer. The slice image 130ₙ is a slice image corresponding to the n-th layer. The slice image 130ₙ₊₁ is a slice image corresponding to the (n+1)-th layer. As illustrated in FIG. 6C, the information processing portion 620 generates grayscale images 140ₙ₋₁, 140ₙ, and 140ₙ₊₁ of a size suitable for the screen of the liquid crystal display 6 respectively on the basis of the slice images 130ₙ₋₁, 130ₙ, and 130ₙ₊₁. The gray scale images 140ₙ₋₁, 140ₙ, and 140ₙ₊₁ include a portion where the three-dimensional shape model 120 is not present, that is, a portion where the light transmittance is set to 0%. A numerical value indicating the gradation value is assigned to each pixel of the grayscale images 140ₙ₋₁, 140ₙ, and 140ₙ₊₁. The information processing portion 620 generates grayscale images of M layers for the slice images of the M layers. To be noted, the grayscale images of the M layers include grayscale images not including gray.

Here, in the case where the gradation value of a pixel of the liquid crystal display 6 is set to “0”, the light transmittance of the pixel is 0%, that is, the pixel hardly transmits incident light. In the case where the gradation value of the pixel of the liquid crystal display 6 is set to “255”, the light transmittance of the pixel is 100%, that is, the pixel transmits all incident light.

In the description below, the light transmittance will be described by using percentage instead of the 256 gradation levels. To be noted, in the setting information 220, the light transmittance, that is, the numerical information indicating the light intensity is defined as 8-bit information.

In the grayscale image 140ₙ₋₁, as illustrated in FIG. 6C, 100% corresponding to white is assigned to a region corresponding to the base portion 22, and 0% corresponding to black is assigned to a region where the shaped object is not to be formed.

In the grayscale image 140ₙ, 100% is assigned to a region corresponding to the base portion 22, and 0% is assigned to a region where the shaped object is not to be formed. In contrast, to a region corresponding to the overhang portion 23, 60%, 70%, 80%, and 90% each indicating gray are assigned in this order as the distance in the X direction from the region corresponding to the base portion 22 is larger.

In the grayscale image 140ₙ₊₁, 100% is assigned to a region corresponding to the base portion 22, and 0% is assigned to a region where the shaped object is not to be formed. In contrast, to a region corresponding to the overhang portion 23, 80%, 90%, 100%, and 100% are assigned in this order as the distance in the X direction from the region corresponding to the base portion 22 is larger.

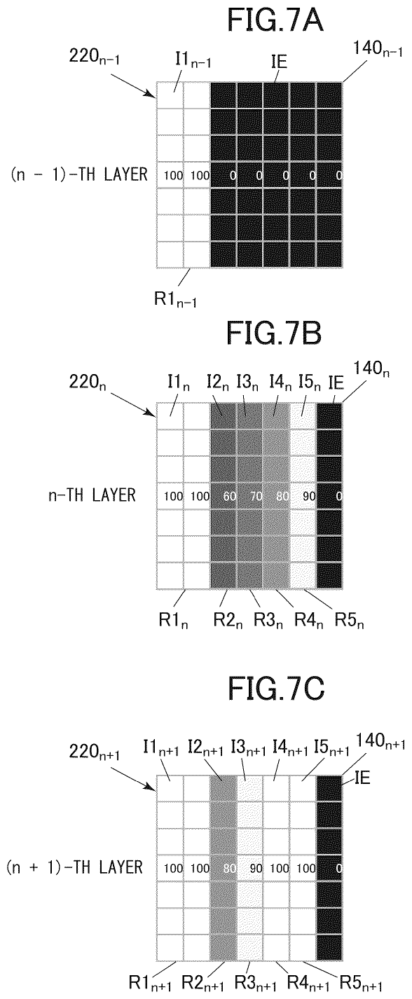

FIGS. 7A to 7C are each an explanatory diagram of the information processing according to the first embodiment. One pixel of the grayscale image corresponds to one pixel of the liquid crystal display 6. In the example of FIGS. 7A to 7C, the grayscale images 140ₙ₋₁, 140ₙ, and 140ₙ₊₁ each include, for example, 7×7=49 pixels. To be noted, the number of pixels is an example used for the sake of convenience of description, and is not limited to this. In addition, one pixel of the grayscale image may correspond to two or more pixels, for example, 2×2=4 pixels of the liquid crystal display 6.

FIG. 7A is an explanatory diagram of setting information 220ₙ₋₁ used for the formation of the (n−1)-th layer according to the first embodiment. FIG. 7B is an explanatory diagram of setting information 220ₙ used for the formation of the n-th layer according to the first embodiment. FIG. 7C is an explanatory diagram of setting information 220ₙ₊₁ used for the formation of the (n+1)-th layer according to the first embodiment. The setting information 220 includes the setting information 220ₙ₋₁, the setting information 220ₙ, and the setting information 220ₙ₊₁.

In the first embodiment, the setting information 220ₙ₋₁ to 220ₙ₊₁ respectively include the grayscale images 140ₙ₋₁ to 140ₙ₊₁ to be displayed on the liquid crystal display 6. The grayscale images 140ₙ₋₁ to 140ₙ₊₁ are image information (image data). To be noted, FIGS. 7A to 7C schematically illustrate layers of the shaped object and the grayscale images 140ₙ₋₁ to 140ₙ₊₁ in association with each other.

The (n−1)-th layer includes a region R1ₙ₋₁ corresponding to the base portion 22. The region R1ₙ₋₁ is an I-shaped region, and corresponds to 14 pixels in the grayscale image 140ₙ₋₁, that is, on the liquid crystal display 6.

The n-th layer includes a region R1ₙ overlapping with the (n−1)-th layer, that is, the region R1ₙ₋₁ in the Z1 direction. The region R1ₙ is an I-shaped region, and corresponds to 14 pixels in the grayscale image 140ₙ, that is, on the liquid crystal display 6.

In addition, the n-th layer includes a region R2ₙ that is continuous with the region R1ₙ and does not overlap with the (n−1)-th layer, that is, the region R1ₙ₋₁ in the Z1 direction. The region R2ₙ is an I-shaped region, and corresponds to 7 pixels in the grayscale image 140ₙ, that is, on the liquid crystal display 6.

In addition, the n-th layer includes a region R3ₙ that is continuous with the region R2ₙ and does not overlap with the (n−1)-th layer, that is, the region R1ₙ₋₁ in the Z1 direction. The region R3ₙ is an I-shaped region, and corresponds to 7 pixels in the grayscale image 140ₙ, that is, on the liquid crystal display 6. The minimum distance from the region R1ₙ to the region R3ₙ is larger than the minimum distance from the region R1ₙ to the region R2ₙ. That is, the region R3ₙ is farther away from the region R1ₙ than the region R2ₙ.

In addition, the n-th layer includes a region R4, that is continuous with the region R3ₙ and does not overlap with the (n−1)-th layer, that is, the region R1ₙ₋₁ in the Z1 direction. The region R4ₙ is an I-shaped region, and corresponds to 7 pixels in the grayscale image 140ₙ, that is, on the liquid crystal display 6. The minimum distance from the region R1ₙ to the region R4, is larger than the minimum distance from the region R1ₙ to the region R3ₙ. That is, the region R4ₙ is farther away from the region R1ₙ than the region R3ₙ.

In addition, the n-th layer includes a region R5ₙ that is continuous with the region R4, and does not overlap with the (n−1)-th layer, that is, the region R1ₙ₋₁ in the Z1 direction. The region R5ₙ is an I-shaped region, and corresponds to 7 pixels in the grayscale image 140ₙ, that is, on the liquid crystal display 6. The minimum distance from the region R1ₙ to the region R5ₙ is larger than the minimum distance from the region R1ₙ to the region R4ₙ. That is, the region R5ₙ is farther away from the region R1ₙ than the region R4ₙ.

Here, the region R1ₙ is an example of a first region. The region R2, is an example of a second region. The region R3ₙ is an example of a third region. The region R1ₙ corresponds to the base portion 22, and the regions R2ₙ to R5ₙ correspond to the overhang portion 23 (overhang surface 24).

The (n+1)-th layer includes a region R1ₙ₊₁ overlapping with the region R1ₙ in the Z1 direction. The region R1ₙ₊₁ is an I-shaped region, and corresponds to 14 pixels in the grayscale image 140ₙ₊₁, that is, on the liquid crystal display 6. The region R1ₙ₊₁ does not overlap with the regions R2ₙ to R5ₙ in the Z1 direction.

In addition, the (n+1)-th layer includes a region R2ₙ₊₁ that is continuous with the region R1ₙ₊₁ and overlaps with the region R2ₙ in the Z1 direction. The region R2ₙ₊₁ is an I-shaped region, and corresponds to 7 pixels in the grayscale image 140ₙ₊₁, that is, on the liquid crystal display 6. The region R2ₙ₊₁ does not overlap with the regions R1ₙ and R3ₙ to R5ₙ in the Z1 direction.

In addition, the (n+1)-th layer includes a region R3ₙ₊₁ that is continuous with the region R2ₙ₊₁ and overlaps with the region R3ₙ in the Z1 direction. The region R3ₙ₊₁ is an I-shaped region, and corresponds to 7 pixels in the grayscale image 140ₙ₊₁, that is, on the liquid crystal display 6. The region R3ₙ₊₁ does not overlap with the regions R1ₙ, R2ₙ, R4ₙ, and R5, in the Z1 direction. The minimum distance from the region R1ₙ₊₁ to the region R3ₙ₊₁ is larger than the minimum distance from the region R1ₙ₊₁ to the region R2ₙ₊₁. That is, the region R3ₙ₊₁ is farther away from the region R1ₙ₊₁ than the region R2ₙ₊₁.

In addition, the (n+1)-th layer includes a region R4ₙ₊₁ that is continuous with the region R3ₙ₊₁ and overlaps with the region R4ₙ in the Z1 direction. The region R4ₙ₊₁ is an I-shaped region, and corresponds to 7 pixels in the grayscale image 140ₙ₊₁, that is, on the liquid crystal display 6. The region R4ₙ₊₁ does not overlap with the regions R1ₙ to R3ₙ and R5ₙ in the Z1 direction. The minimum distance from the region R1ₙ₊₁ to the region R4ₙ₊₁ is larger than the minimum distance from the region R1ₙ₊₁ to the region R3ₙ₊₁. That is, the region R4ₙ₊₁ is farther away from the region R1ₙ₊₁ than the region R3ₙ₊₁.

In addition, the (n+1)-th layer includes a region R5ₙ₊₁ that is continuous with the region R4ₙ₊₁ and overlaps with the region R5ₙ in the Z1 direction. The region R5ₙ₊₁ is an I-shaped region, and corresponds to 7 pixels in the grayscale image 140ₙ₊₁, that is, on the liquid crystal display 6. The region R5ₙ₊₁ does not overlap with the regions R1ₙ to R4, in the Z1 direction. The minimum distance from the region R1ₙ₊₁ to the region R5ₙ₊₁ is larger than the minimum distance from the region R1ₙ₊₁ to the region R4ₙ₊₁. That is, the region R5ₙ₊₁ is farther away from the region R1ₙ₊₁ than the region R4ₙ₊₁.

Here, the region R1ₙ₊₁ is an example of a fourth region. The region R2ₙ₊₁ is an example of a fifth region. The region R3ₙ₊₁ is an example of a sixth region. The region R1ₙ₊₁ corresponds to the base portion 22, and the regions R2ₙ₊₁ to R5ₙ₊₁ correspond to the overhang portion 23.

The grayscale image 140ₙ₋₁ includes information for setting the energy radiated by the light irradiation portion 5 in the formation of the (n−1)-th layer (region R1ₙ₋₁) to intensity I1ₙ₋₁.

Specifically, in the first embodiment, the grayscale image 140ₙ₋₁ includes information for setting the intensity of the light transmitted through pixels corresponding to the (n−1)-th layer among the plurality of pixels of the liquid crystal display 6 to the intensity I1ₙ₋₁ in the formation of the (n−1)-th layer.

The intensity I1ₙ₋₁ is, for example, the intensity of the transmitted light in the case where the light transmittance of the pixel of the liquid crystal display 6 is 100%.

In addition, the grayscale image 140ₙ₋₁ includes information for setting the intensity of light transmitted through pixels other than the pixels corresponding to the (n−1)-th layer (region R1_{n-1) among the plurality of pixels of the liquid crystal display 6 to intensity IE. The intensity IE is intensity of the transmitted light in the case where the light transmittance of the pixel of the liquid crystal display 6 is} 0%.

The grayscale image 140ₙ includes information for setting the intensity of the energy radiated by the light irradiation portion 5 in the formation of the region R1ₙ to intensity I1ₙ. In addition, the grayscale image 140ₙ includes information for setting the intensity of the energy radiated by the light irradiation portion 5 in the formation of the region R2ₙ to intensity I2ₙ. In addition, the grayscale image 140ₙ includes information for setting the intensity of the energy radiated by the light irradiation portion 5 in the formation of the region R3ₙ to intensity I3ₙ. In addition, the grayscale image 140ₙ includes information for setting the intensity of the energy radiated by the light irradiation portion 5 in the formation of the region R4ₙ to intensity I4ₙ. In addition, the grayscale image 140ₙ includes information for setting the intensity of the energy radiated by the light irradiation portion 5 in the formation of the region R5ₙ to intensity I5ₙ.

Specifically, in the first embodiment, the grayscale image 140ₙ includes information for setting the intensity of light transmitted through pixels corresponding to the region R1ₙ among the plurality of pixels of the liquid crystal display 6 to intensity I1ₙ in the formation of the region R1ₙ. In addition, the grayscale image 140ₙ includes information for setting the intensity of light transmitted through pixels corresponding to the region R2, among the plurality of pixels of the liquid crystal display 6 to intensity I2ₙ in the formation of the region R2ₙ. In addition, the grayscale image 140ₙ includes information for setting the intensity of light transmitted through pixels corresponding to the region R3ₙ among the plurality of pixels of the liquid crystal display 6 to intensity I3ₙ in the formation of the region R3ₙ. In addition, the grayscale image 140ₙ includes information for setting the intensity of light transmitted through pixels corresponding to the region R4, among the plurality of pixels of the liquid crystal display 6 to intensity I4ₙ in the formation of the region R4ₙ. In addition, the grayscale image 140ₙ includes information for setting the intensity of light transmitted through pixels corresponding to the region R5ₙ among the plurality of pixels of the liquid crystal display 6 to intensity I5ₙ in the formation of the region R5ₙ.

In the first embodiment, the intensity I1ₙ is equal to intensity I1ₙ₋₁. The intensity I2ₙ is lower than the intensity I1ₙ. The intensity I3ₙ is higher than the intensity I2ₙ. The intensity I4ₙ is higher than the intensity I3ₙ. The intensity I5ₙ is higher than the intensity I4ₙ. In addition, the intensities I3ₙ to I5ₙ are lower than the intensity I1ₙ. Here, the intensity I1ₙ is an example of first intensity. The intensity I2ₙ is an example of second intensity. The intensity I3ₙ is an example of third intensity.

As described above, in the first embodiment, a relationship of I2ₙ<I3ₙ<I4ₙ<I5ₙ<I1ₙ is satisfied. To be noted, as a modification example, a relationship of I2ₙ<I3ₙ<I4ₙ<I5ₙ≤I1ₙ may be satisfied. That is, the intensity I5ₙ may be equal to or lower than the intensity I1ₙ. In addition, as another modification example, a relationship of I2ₙ<I3ₙ<I4ₙ≤I5ₙ≤I1ₙ may be satisfied. That is, the intensities I4ₙ and I5ₙ may be equal to or lower than the intensity I1ₙ. In addition, as yet another modification example, a relationship of I2ₙ<I3ₙ≤I4ₙ≤I5ₙ≤I1ₙ may be satisfied. That is, the intensities I3ₙ to I5ₙ may be equal to or lower than the intensity I1ₙ.

In addition, the region R5ₙ may be omitted. In addition, the regions R4, and R5ₙ may be omitted. In addition, the regions R3ₙ to R5ₙ may be omitted.

In the example of FIG. 7B, the intensity I1ₙ is, for example, the intensity of the transmitted light in the case where the light transmittance of the pixel of the liquid crystal display 6 is 100%. The intensity I2ₙ is, for example, the intensity of the transmitted light in the case where the light transmittance of the pixel of the liquid crystal display 6 is 60%. The intensity I3ₙ is, for example, the intensity of the transmitted light in the case where the light transmittance of the pixel of the liquid crystal display 6 is 70%. The intensity I4ₙ is, for example, the intensity of the transmitted light in the case where the light transmittance of the pixel of the liquid crystal display 6 is 80%. The intensity I5, is, for example, the intensity of the transmitted light in the case where the light transmittance of the pixel of the liquid crystal display 6 is 90%.

In addition, the grayscale image 140ₙ includes information for setting the intensity of light transmitted through pixels other than the pixels corresponding to the n-th layer (regions R1ₙ to R5ₙ) among the plurality of pixels of the liquid crystal display 6 to intensity IE.

The grayscale image 140ₙ₊₁ includes information for setting the intensity of the energy radiated by the light irradiation portion 5 in the formation of the region R1ₙ₊₁ to intensity I1ₙ₊₁. In addition, the grayscale image 140ₙ₊₁ includes information for setting the intensity of the energy radiated by the light irradiation portion 5 in the formation of the region R2ₙ₊₁ to intensity I2ₙ₊₁. In addition, the grayscale image 140ₙ₊₁ includes information for setting the intensity of the energy radiated by the light irradiation portion 5 in the formation of the region R3ₙ₊₁ to intensity I3ₙ₊₁. In addition, the grayscale image 140ₙ₊₁ includes information for setting the intensity of the energy radiated by the light irradiation portion 5 in the formation of the region R4ₙ₊₁ to intensity I4ₙ₊₁. In addition, the grayscale image 140ₙ₊₁ includes information for setting the intensity of the energy radiated by the light irradiation portion 5 in the formation of the region R5ₙ₊₁ to intensity I5ₙ₊₁.

Specifically, in the first embodiment, the grayscale image 140ₙ₊₁ includes information for setting the intensity of light transmitted through pixels corresponding to the region R1ₙ₊₁ among the plurality of pixels of the liquid crystal display 6 to intensity I1ₙ₊₁ in the formation of the region R1ₙ₊₁. In addition, the grayscale image 140ₙ₊₁ includes information for setting the intensity of light transmitted through pixels corresponding to the region R2ₙ₊₁ among the plurality of pixels of the liquid crystal display 6 to intensity I2ₙ₊₁ in the formation of the region R2ₙ₊₁. In addition, the grayscale image 140ₙ₊₁ includes information for setting the intensity of light transmitted through pixels corresponding to the region R3ₙ₊₁ among the plurality of pixels of the liquid crystal display 6 to intensity I3ₙ₊₁ in the formation of the region R3ₙ₊₁. In addition, the grayscale image 140ₙ₊₁ includes information for setting the intensity of light transmitted through pixels corresponding to the region R4ₙ₊₁ among the plurality of pixels of the liquid crystal display 6 to intensity I4ₙ₊₁ in the formation of the region R4ₙ₊₁. In addition, the grayscale image 140ₙ₊₁ includes information for setting the intensity of light transmitted through pixels corresponding to the region R5ₙ₊₁ among the plurality of pixels of the liquid crystal display 6 to intensity I5ₙ₊₁ in the formation of the region R5ₙ₊₁.

In the first embodiment, the intensity I1ₙ₊₁ is equal to the intensities I1ₙ₋₁ and I1ₙ. The intensity I2ₙ₊₁ is lower than the intensity I1ₙ₊₁. The intensity I3ₙ₊₁ is higher than the intensity I2ₙ₊₁. The intensities I4ₙ₊₁ and I5ₙ₊₁ are higher than the intensity I3ₙ₊₁. In addition, the intensity I3ₙ₊₁ is lower than the intensity I1ₙ₊₁. The intensities I4ₙ₊₁ and I5ₙ₊₁ are equal to the intensities I1ₙ₋₁ and I1ₙ. Here, the intensity I1ₙ₊₁ is an example of fourth intensity. The intensity I2ₙ₊₁ is an example of fifth intensity. The intensity I3ₙ₊₁ is an example of sixth intensity.

As described above, in the first embodiment, a relationship of I2ₙ₊₁<I3ₙ₊₁<I4ₙ₊₁<I5ₙ₊₁<I1ₙ₊₁ is satisfied. That is, the intensities I4ₙ₊₁ and I5ₙ₊₁ are equal to or lower than the intensity I1ₙ₊₁. To be noted, as a modification example, a relationship of I2ₙ₊₁<I3ₙ₊₁<I4ₙ₊₁<I5ₙ₊₁<I1ₙ₊₁ may be satisfied. In addition, as another modification example, a relationship of I2ₙ₊₁<I3ₙ₊₁<I4ₙ₊₁<I5ₙ₊₁≤I1ₙ₊₁ may be satisfied. That is, the intensity I5ₙ₊₁ may be equal to or lower than the intensity I1ₙ₊₁. In addition, as yet another modification example, a relationship of I2ₙ₊₁<I3ₙ₊₁<I4ₙ₊₁≤I5ₙ₊₁≤I1ₙ₊₁ may be satisfied. That is, the intensities I3ₙ₊₁ to I5ₙ₊₁ may be equal to or lower than the intensity I1ₙ₊₁.

In addition, in the first embodiment, the intensity I2ₙ₊₁ is higher than the intensity I2ₙ. The intensity I2ₙ₊₁ is higher than the intensity I3ₙ. The intensity I2ₙ₊₁ is equal to the intensity I4ₙ. In addition, in the first embodiment, the intensity I3ₙ₊₁ is higher than the intensity I3ₙ. The intensity I3ₙ₊₁ is higher than the intensity I4ₙ. The intensity I3ₙ₊₁ is equal to the intensity I5ₙ. In addition, in the first embodiment, the intensity I4ₙ₊₁ is higher than the intensity I4ₙ. The intensity I4ₙ₊₁ is higher than the intensity I5ₙ. In addition, in the first embodiment, the intensity I5ₙ₊₁ is higher than the intensity I5ₙ.

In addition, the region R5ₙ₊₁ may be omitted. In addition, the regions R4ₙ₊₁ and R5ₙ₊₁ may be omitted. In addition, the regions R3ₙ₊₁ to R5ₙ₊₁ may be omitted.

In the example of FIG. 7C, the intensity I1ₙ₊₁ is, for example, the intensity of the transmitted light in the case where the light transmittance of the pixel of the liquid crystal display 6 is 100%. The intensity I2ₙ₊₁ is, for example, the intensity of the transmitted light in the case where the light transmittance of the pixel of the liquid crystal display 6 is 80%. The intensity I3ₙ₊₁ is, for example, the intensity of the transmitted light in the case where the light transmittance of the pixel of the liquid crystal display 6 is 90%. The intensity I4ₙ₊₁ is, for example, the intensity of the transmitted light in the case where the light transmittance of the pixel of the liquid crystal display 6 is 100%. The intensity I5ₙ₊₁ is, for example, the intensity of the transmitted light in the case where the light transmittance of the pixel of the liquid crystal display 6 is 100%.

In addition, the grayscale image 140ₙ₊₁ includes information for setting the intensity of light transmitted through pixels other than the pixels corresponding to the (n+1)-th layer (regions R1ₙ₊₁ to R5ₙ₊₁) among the plurality of pixels of the liquid crystal display 6 to intensity IE.

As described above, in the grayscale image 140ₙ₋₁ not including a pixel corresponding to the overhang portion 23, the pixels corresponding to the shaped object is expressed by white, and in the grayscale images 140ₙ and 140ₙ₊₁ including a pixel corresponding to the overhang portion 23, the pixels corresponding to the shaped object are expressed by either white or gray.

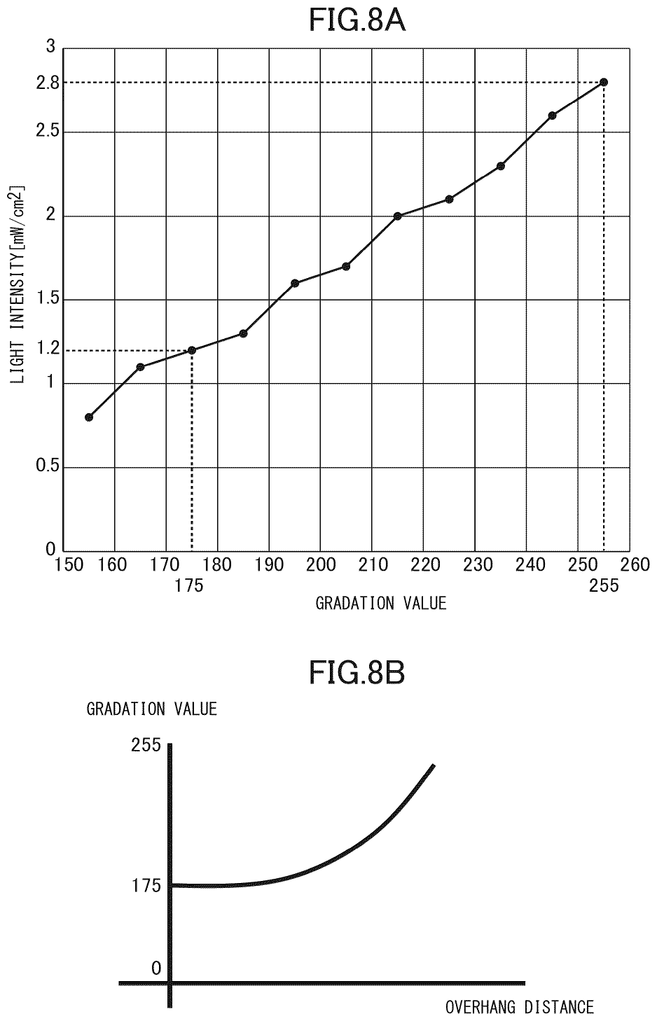

Here, the relationship between the gradation value of the grayscale and the light intensity will be described. FIG. 8A is a graph illustrating the relationship between the gradation value of the grayscale and the light intensity according to the first embodiment. The light intensity shown in FIG. 8A is the intensity of ultraviolet light. As illustrated in FIG. 8A, as the gradation value of the grayscale increases, the light transmittance also increases, and thus the light intensity increases.

From the viewpoint of photocuring the photocurable resin composition 1, it is preferable that the light intensity is adjusted within the range of 1.2 mW/cm² to 2.8 mW/cm² in the optical shaping of the shaped object 20, and the range of the gradation value corresponding to this range is a range of 175 to 255.

FIG. 8B is a graph illustrating the relationship between the overhang distance and the gradation value according to the first embodiment. The overhang distance is the distance from the base portion 22 to a position on the overhang portion 23 away therefrom in the X direction. As illustrated in FIG. 8B, the gradation value is adjusted to decrease within the range of 175 to 255 as the position is closer to the base portion 22 in the X direction. To be noted, the gradation value of the grayscale images 140ₙ₋₁ to 140ₙ₊₁ and the gradation value of the liquid crystal display 6 are in correspondence with each other.

In the grayscale images 140ₙ₋₁ to 140ₙ₊₁, the gradation value is set to 255 for the region corresponding to the base portion 22 such that the light intensities I1ₙ₋₁, I1ₙ, and I1ₙ₊₁ are 2.8 mW/cm².

In contrast, for the region corresponding to the overhang portion 23, the gradation value is set within the range of 175 or more and less than 255 such that the light intensities I2ₙ to 15ₙ are within the range of 1.2 mW/cm² or more and less than 2.8 mW/cm². For example, for the light intensity I2ₙ, the gradation value is set to 175 such that the light intensity I2ₙ is 1.2 mW/cm².

Here, the ratio of 175 to 255 is about 0.68, that is, about 2/3. Therefore, in the grayscale images 140ₙ₋₁ to 140ₙ₊₁, the gradation value of the region corresponding to the shaped object 20 is set such that the ratio of the gradation value to the maximum gradation value (255) is within the range of 2/3 or more and 1 or less.

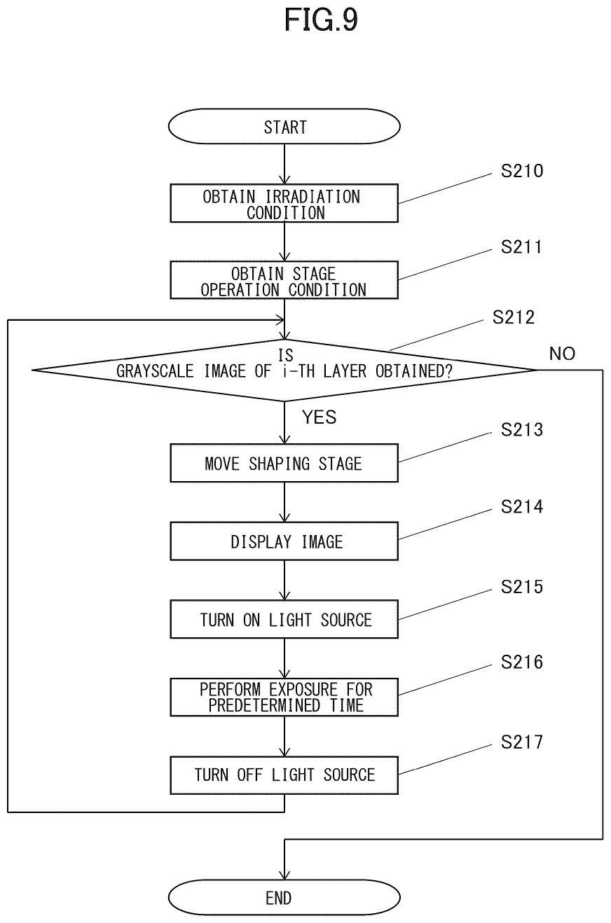

The setting information 220 generated as described above is transmitted to the control apparatus 200, and the shaped object 20 is manufactured in the shaping apparatus 100. The manufacturing method for the shaped object 20 will be described. FIG. 9 is a flowchart of the manufacturing method for the shaped object 20 according to the first embodiment. The container 2 is filled with the uncured photocurable resin composition 1.

First, in step S210, the light source control portion 605 obtains the irradiation condition. The irradiation condition includes a time in which the grayscale image is projected onto the photocurable resin composition 1 in the container 2, that is, the timings of on and off of the light source 8 and the time period in which the light source 8 is on.

In addition, in step S211, the stage control portion 606 obtains the operation condition of the shaping stage 3. The operation condition of the shaping stage 3 includes, for example, the operation distance, operation speed, and operation timing of the shaping stage 3.

In step S212, whether or not the liquid crystal control portion 607 has obtained a grayscale image of the i-th layer is determined, where i is a positive integer of 1 to M. The initial value of i is 1. That is, whether or not the grayscale image of the first layer has been obtained is determined first.

In the case where the result of step S212 is YES, in step S213, the stage control portion 606 controls the lifting apparatus 4 to move the shaping stage 3 such that the distance between the shaping stage 3 or an already-formed shaped layer and the releasing transmitting film film 7 is equal to Δt that is the thickness per layer of the shaped object 20.

Next, in step S214, the liquid crystal control portion 607 displays the grayscale image of the i-th layer on the liquid crystal display 6. That is, the liquid crystal control portion 607 draws the cured shape of the layer on the liquid crystal display 6.

In step S215, the light source control portion 605 controls the light source 8 to turn on the light source 8. In step S216, the light source control portion 605 keeps the on state of the light source 8 such that the photocurable resin composition 1 in the container 2 is exposed to light for a predetermined time.

After the predetermined time has elapsed, in step S217, the light source control portion 605 turns off the light source 8. As a result of this, the photocurable resin composition 1 present under the shaping stage 3 is selectively cured.

Returning to step S212, the liquid crystal control portion 607 determines whether or not the grayscale image of the second layer that is the next layer has been obtained. As a result of steps S212 to S217 being repeated from i=1 to i=M, the shaped object 20 is manufactured. Then, the supports 29 are removed from the shaped object 20, and thus the shaped product 21 is obtained.

Here, in the formation of the n-th layer including the overhang surface 24, the grayscale image 140ₙ illustrated in FIG. 7B is displayed on the liquid crystal display 6. In the first embodiment, since the intensity of the light 10 radiated onto the regions R2ₙ to R5ₙ corresponding to the overhang portion 23 is lower than the intensity of the light 10 radiated onto the region R1ₙ corresponding to the base portion 22, the amount of light transmitted to the photocurable resin composition 1 of a layer higher than the n-th layer is reduced. As a result of the intensity of light emitted from the liquid crystal display 6 being adjusted for each pixel, formation of the excess shaped portion on the overhang portion 23 can be prevented or suppressed, and therefore the shaped object 20, that is, the shaped product 21 having a highly precise shape close to the three-dimensional shape model can be obtained, and the post-processing for adjusting the shape of the shaped product 21 can be reduced, or removal of the shaped product 21 as a defected product can be suppressed. Therefore, the manufacturing cost of the shaped product 21 can be reduced.

In addition, the intensity of the diffused reflection light at the corner portion of an already-shaped portion of the base portion 22, for example, the corner portion of the region R1ₙ₋₁ is higher at a position closer to the region R1ₙ. Particularly, in the region R2ₙ, the diffused reflection light is more influential because the region R2, is a region continuous with the region R1ₙ and is close to the region R1ₙ₋₁. In the first embodiment, the intensity of light radiated from the liquid crystal display 6 decreases stepwise as the region is closer to the region R1ₙ. Specifically, the light intensity is set to satisfy a relationship of I2ₙ<I3ₙ<I4ₙ<I5ₙ<I1ₙ. Particularly, the amount of light transmitted to the photocurable resin composition 1 in the region R2ₙ or higher is reduced. As a result of this, the intensity distribution of the light radiated onto the regions R2ₙ to R5ₙ is substantially equalized. As a result of this, the formation of the excess shaped portion on the overhang portion 23 is prevented or suppressed, and therefore the shaped object 20, that is, the shaped product 21 having a more highly precise shape can be obtained. To be noted, since the diffused reflection light is less influential as the region is farther away from the region R1ₙ in the X direction, the intensity of the transmitted light of the liquid crystal display 6 may be set to I5ₙ=I1ₙ, 14ₙ=I5ₙ=I1ₙ, or I3ₙ=I4ₙ=I5ₙ=I1ₙ.

In the formation of the (n+1)-th layer next to the n-th layer, the grayscale image 140ₙ₊₁ illustrated in FIG. 7C is displayed on the liquid crystal display 6. In the first embodiment, since the intensity of the light 10 radiated onto the regions R2ₙ₊₁ and R3ₙ₊₁ corresponding to the overhang portion 23 from the liquid crystal display 6 is lower than the intensity of the light 10 radiated onto the region R1ₙ₊₁ corresponding to the base portion 22 from the liquid crystal display 6, the amount of light transmitted to a position higher than the (n+1)-th layer is reduced. As a result of this, formation of the excess shaped portion on the overhang portion 23 can be prevented or suppressed, and therefore the shaped object 20, that is, the shaped product 21 having a highly precise shape close to the three-dimensional shape model can be obtained, and the post-processing for adjusting the shape of the shaped product 21 can be reduced, or removal of the shaped product 21 as a defected product can be suppressed. Therefore, the manufacturing cost of the shaped product 21 can be reduced.

In addition, when forming the (n+1)-th layer, since the n-th layer has been already formed, a portion where diffused reflection of light is likely to occur, for example, the corner portion of the region Rn−1 of the (n−1)-th layer is surrounded by the n-th layer. Therefore, the intensity of light reaching the portion where the diffused reflection of light is likely to occur is reduced. That is, the occurrence of diffused reflection light is reduced, and therefore the intensity of the light 10 radiated from the liquid crystal display 6 can be made closer to I1ₙ₊₁. Therefore, the light intensities I2ₙ₊₁ to I5ₙ₊₁ for forming the regions R2ₙ₊₁ to R5ₙ₊₁ of the (n+1)-th layer may be respectively higher than the intensities I2ₙ to I5ₙ for forming the regions R2ₙ to R5ₙ of the n-th layer. Specifically, I2ₙ₊₁>I2ₙ, I3ₙ₊₁>I3ₙ, I4ₙ₊₁>I4ₙ, and I5ₙ₊₁>I5ₙ are set. As a result of this, the (n+1)-th layer can be efficiently cured. In addition, since the intensity of the light used for curing the (n+1)-th layer is made higher than the intensity of the light used for curing the n-th layer, light attenuated by the (n+1)-th layer can reach the n-th layer, but curing of the n-th layer can be promoted by this attenuated light. As a result of this, the n-th layer can be also efficiently cured.

### Second Embodiment

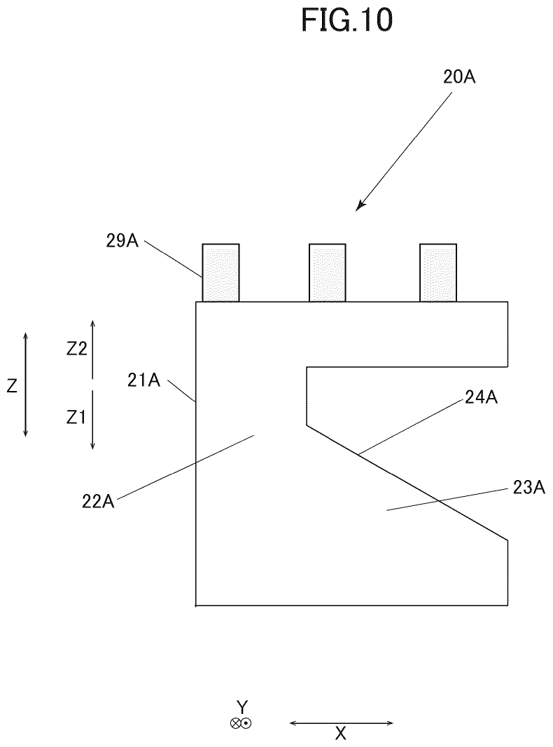

A second embodiment will be described. In the second embodiment, description of elements common to the first embodiment will be simplified or omitted. FIG. 10 is a schematic view of a shaped object 20A according to the second embodiment. In the second embodiment, the shape of the shaped object 20A to be formed is different from the shape of the shaped object 20 of the first embodiment. The shaped object 20A includes a shaped product 21A and supports 29A. The shaped product 21A includes a base portion 22A and an overhang portion 23A. In the second embodiment, an overhang surface 24A is an inclined surface. The configuration of the shaping system of the second embodiment is substantially the same as the configuration of the shaping system 1000 of the first embodiment.

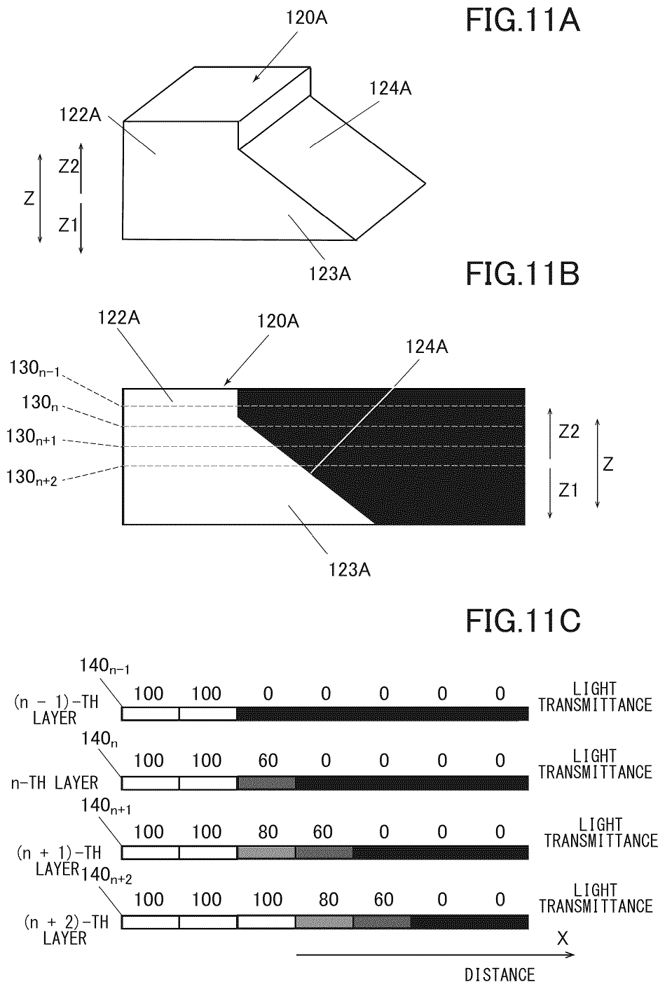

FIGS. 11A to 11C are each an explanatory diagram of information processing according to the second embodiment. FIG. 11A is a perspective view schematically illustrating part of a three-dimensional shape model 120A corresponding to the shaped object 20A as a three-dimensional image. The information processing portion 620 slices the three-dimensional shape model 120A illustrated in FIG. 11A and obtains slice images 130ₙ₋₁, 130ₙ, 130ₙ₊₁, and 130ₙ₊₂ illustrated in FIG. 11B, where n is an integer of 2 or more.

Here, the three-dimensional shape model 120A includes a portion 122A corresponding to the base portion 22A and a portion 123A corresponding to the overhang portion 23A. The portion 123A includes a portion 124A corresponding to the overhang surface 24A.

The slice image 130ₙ₋₁ is slice data including the portion 122A corresponding to the base portion 22A. The slice image 130ₙ is slice data including the portion 122A corresponding to the base portion 22A and the portion 123A corresponding to the overhang portion 23A. The slice image 130ₙ₊₁ is slice data including the portion 122A corresponding to the base portion 22A and the portion 123A corresponding to the overhang portion 23A. The slice image 130ₙ₊₂ is slice data including the portion 122A corresponding to the base portion 22A and the portion 123A corresponding to the overhang portion 23A.

The slice image 130ₙ₋₁ is a slice image corresponding to the (n−1)-th layer. The slice image 130ₙ is a slice image corresponding to the n-th layer. The slice image 130ₙ₊₁ is a slice image corresponding to the (n+1)-th layer. The slice image 130ₙ₊₂ is a slice image corresponding to the (n+2)-th layer. As illustrated in FIG. 11C, the information processing portion 620 generates grayscale images 140ₙ₋₁, 140ₙ, 140ₙ₊₁, and 140ₙ₊₂ of a size suitable for the screen of the liquid crystal display 6 respectively on the basis of the slice images 130ₙ₋₁, 130ₙ, 130ₙ₊₁ and 130ₙ₊₂. The grayscale images 140ₙ₋₁, 140ₙ, 140ₙ₊₁, and 140ₙ₊₂ include a portion where the three-dimensional shape model 120A is not present, that is, a portion where the light transmittance is set to 0%. A numerical value indicating the gradation value is assigned to each pixel of the grayscale images 140ₙ₋₁, 140ₙ, 140ₙ₊₁, and 140ₙ₊₂.

In the description below, the light transmittance will be described by using percentage instead of the 256 gradation levels. To be noted, in the setting information 220, the light transmittance, that is, the numerical information indicating the light intensity is defined as 8-bit information.

In the grayscale image 140ₙ₋₁, as illustrated in FIG. 11C, 100% corresponding to white is assigned to a region corresponding to the base portion 22A, and 0% corresponding to black is assigned to a region where the shaped object is not to be formed.

In the grayscale image 140ₙ, 100% is assigned to a region corresponding to the base portion 22A, and 0% is assigned to a region where the shaped object is not to be formed. In contrast, 60% indicating gray is assigned to a region corresponding to the overhang portion 23A.

In the grayscale image 140ₙ₊₁, 100% is assigned to a region corresponding to the base portion 22A, and 0% is assigned to a region where the shaped object is not to be formed. In contrast, to a region corresponding to the overhang portion 23A, 80% and 60% are assigned in this order as the distance in the X direction from the region corresponding to the base portion 22A is larger.

In the grayscale image 140ₙ₊₂, 100% is assigned to a region corresponding to the base portion 22A, and 0% is assigned to a region where the shaped object is not to be formed. In contrast, to a region corresponding to the overhang portion 23A, 100%, 80%, and 60% are assigned in this order as the distance in the X direction from the region corresponding to the base portion 22A is larger.

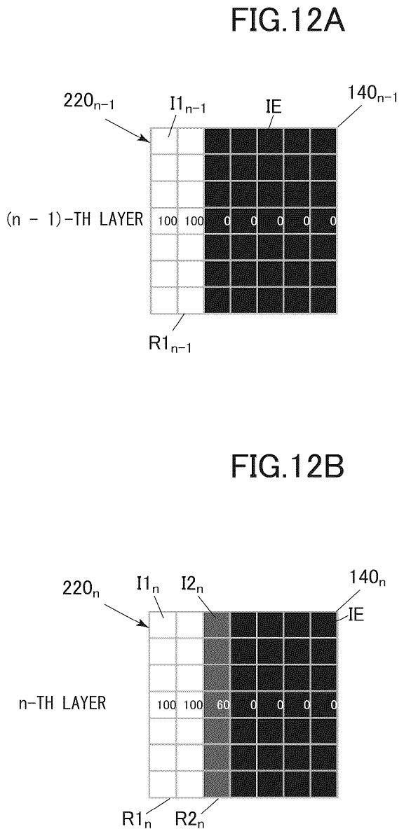

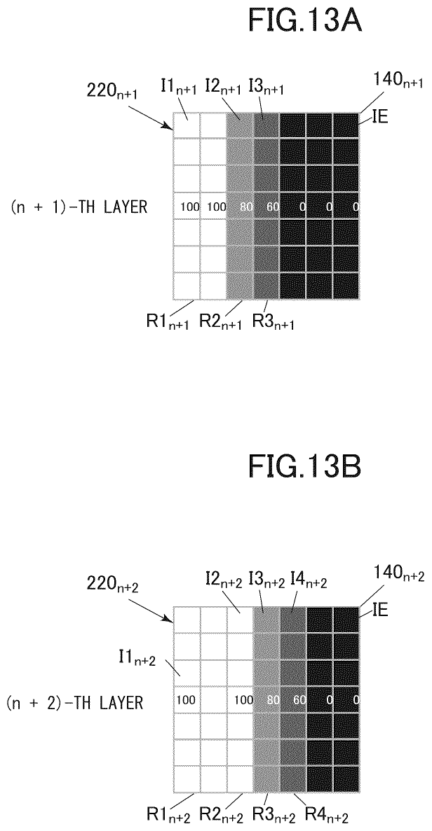

FIGS. 12A to 13B are each an explanatory diagram of the information processing according to the second embodiment. One pixel of the grayscale image corresponds to one pixel of the liquid crystal display 6. In the example of FIGS. 12A to 13B, the grayscale images 140ₙ₋₁, 140ₙ, 140ₙ₊₁, and 140ₙ₊₂ each include, for example, 7×7=49 pixels. To be noted, the number of pixels is an example used for the sake of convenience of description, and is not limited to this. In addition, one pixel of the grayscale image may correspond to two or more pixels, for example, 2×2=4 pixels of the liquid crystal display 6.

FIG. 12A is an explanatory diagram of setting information 220ₙ₋₁ used for the formation of the (n−1)-th layer according to the second embodiment. FIG. 12B is an explanatory diagram of setting information 220ₙ used for the formation of the n-th layer according to the second embodiment. FIG. 13A is an explanatory diagram of setting information 220ₙ₊₁ used for the formation of the (n+1)-th layer according to the second embodiment. FIG. 13B is an explanatory diagram of setting information 220ₙ₊₂ used for the formation of the (n+2)-th layer according to the second embodiment. The setting information 220 includes the setting information 220ₙ₋₁, the setting information 220ₙ, the setting information 220ₙ₊₁, and the setting information 220ₙ₊₂.

In the second embodiment, the setting information 220ₙ₋₁ to 220ₙ₊₂ respectively include the grayscale images 140ₙ₋₁ to 140ₙ₊₂ to be displayed on the liquid crystal display 6. The grayscale images 140ₙ₋₁ to 140ₙ₊₂ are image information (image data). To be noted, FIGS. 12A to 13B schematically illustrate layers of the shaped object and the grayscale images 140ₙ₋₁ to 140ₙ₊₂ in association with each other for the sake of convenience of description.

The (n−1)-th layer includes a region R1ₙ₋₁ corresponding to the base portion 22A. The region R1ₙ₋₁ is an I-shaped region, and corresponds to 14 pixels in the grayscale image 140ₙ₋₁, that is, on the liquid crystal display 6.

The n-th layer includes a region R1ₙ overlapping with the (n−1)-th layer, that is, the region R1ₙ₋₁ in the Z1 direction. The region R1ₙ is an I-shaped region, and corresponds to 14 pixels in the grayscale image 140ₙ, that is, on the liquid crystal display 6.

In addition, the n-th layer includes a region R2, that is continuous with the region R1ₙ and does not overlap with the (n−1)-th layer, that is, the region R1ₙ₋₁ in the Z1 direction. The region R2ₙ is an I-shaped region, and corresponds to 7 pixels in the grayscale image 140ₙ, that is, on the liquid crystal display 6.

Here, the region R1, is an example of a first region. The region R2, is an example of a second region. The region R1ₙ corresponds to the base portion 22A, and the region R2ₙ corresponds to the overhang portion 23A (overhang surface 24A).

The (n+1)-th layer includes a region R1ₙ₊₁ overlapping with the region R1ₙ in the Z1 direction. The region R1ₙ₊₁ is an I-shaped region, and corresponds to 14 pixels in the grayscale image 140ₙ₊₁, that is, on the liquid crystal display 6.

In addition, the (n+1)-th layer includes a region R2ₙ₊₁ that is continuous with the region R1ₙ₊₁ and overlaps with the region R2ₙ in the Z1 direction. The region R2ₙ₊₁ is an I-shaped region, and corresponds to 7 pixels in the grayscale image 140ₙ₊₁, that is, on the liquid crystal display 6. The region R2ₙ₊₁ does not overlap with the region R1ₙ in the Z1 direction.

In addition, the (n+1)-th layer includes a region R3ₙ₊₁ that is continuous with the region R2ₙ₊₁ and does not overlap with the n-th layer, that is, the regions R1ₙ and R2ₙ in the Z1 direction. The region R3ₙ₊₁ is an I-shaped region, and corresponds to 7 pixels in the grayscale image 140ₙ₊₁, that is, on the liquid crystal display 6. The minimum distance from the region R1ₙ₊₁ to the region R3ₙ₊₁ is larger than the minimum distance from the region R1ₙ₊₁ to the region R2ₙ₊₁. That is, the region R3ₙ₊₁ is farther away from the region R1ₙ₊₁ than the region R2ₙ₊₁.

Here, the region R1ₙ₊₁ is an example of a fourth region. The region R2ₙ₊₁ is an example of a fifth region. The region R3ₙ₊₁ is an example of a sixth region. The region R1ₙ₊₁ corresponds to the base portion 22A, and the regions R2ₙ₊₁ and R3ₙ₊₁ correspond to the overhang portion 23A.

The (n+2)-th layer includes a region R1ₙ₊₂ overlapping with the region R1ₙ₊₁ in the Z1 direction. The region R1ₙ₊₂ is an I-shaped region, and corresponds to 14 pixels in the grayscale image 140ₙ₊₂, that is, on the liquid crystal display 6.

In addition, the (n+2)-th layer includes a region R2ₙ₊₂ that is continuous with the region R1ₙ₊₂ and overlaps with the region R2ₙ₊₁ in the Z1 direction. The region R2ₙ₊₂ is an I-shaped region, and corresponds to 7 pixels in the grayscale image 140ₙ₊₂, that is, on the liquid crystal display 6. The region R2ₙ₊₂ does not overlap with the regions R1ₙ₊₁ and R3ₙ₊₁ in the Z1 direction.

In addition, the (n+2)-th layer includes a region R3ₙ₊₂ that is continuous with the region R2ₙ₊₂ and overlaps with the region R3ₙ₊₁ in the Z1 direction. The region R3ₙ₊₂ is an I-shaped region, and corresponds to 7 pixels in the grayscale image 140ₙ₊₂, that is, on the liquid crystal display 6. The region R3ₙ₊₂ does not overlap with the regions R1ₙ₊₁ and R2ₙ₊₁ in the Z1 direction. The minimum distance from the region R1ₙ₊₂ to the region R3ₙ₊₂ is larger than the minimum distance from the region R1ₙ₊₂ to the region R2ₙ₊₂. That is, the region R3ₙ₊₂ is farther away from the region R1ₙ₊₂ than the region R2ₙ₊₂.

In addition, the (n+2)-th layer includes a region R4ₙ₊₂ that is continuous with the region R3ₙ₊₂ and does not overlap with the (n+1)-th layer, that is, the regions R1ₙ₊₁ to R3ₙ₊₁ in the Z1 direction. The region R4ₙ₊₂ is an I-shaped region, and corresponds to 7 pixels in the grayscale image 140ₙ₊₂, that is, on the liquid crystal display 6. The minimum distance from the region R1ₙ₊₂ to the region R4ₙ₊₂ is larger than the minimum distance from the region R1ₙ₊₂ to the region R3ₙ₊₂. That is, the region R4ₙ₊₂ is farther away from the region R1ₙ₊₂ than the region R3ₙ₊₂.

The grayscale image 140ₙ₋₁ includes information for setting the energy radiated by the light irradiation portion 5 in the formation of the (n−1)-th layer (region R1ₙ₋₁) to intensity I1ₙ₋₁.

Specifically, in the second embodiment, the grayscale image 140ₙ₋₁ includes information for setting the intensity of the light transmitted through pixels corresponding to the (n−1)-th layer among the plurality of pixels of the liquid crystal display 6 to the intensity I1ₙ₋₁ in the formation of the (n−1)-th layer.

The intensity I1ₙ₋₁ is, for example, the intensity of the transmitted light in the case where the light transmittance of the pixel of the liquid crystal display 6 is 100%.

In addition, the grayscale image 140ₙ₋₁ includes information for setting the intensity of light transmitted through pixels other than the pixels corresponding to the (n−1)-th layer (region R1ₙ₋₁) among the plurality of pixels of the liquid crystal display 6 to intensity IE. The intensity IE is intensity of the transmitted light in the case where the light transmittance of the pixel of the liquid crystal display 6 is 0%.

The grayscale image 140ₙ includes information for setting the intensity of the energy radiated by the light irradiation portion 5 in the formation of the region R1ₙ to intensity I1ₙ. In addition, the grayscale image 140ₙ includes information for setting the intensity of the energy radiated by the light irradiation portion 5 in the formation of the region R2ₙ to intensity I2ₙ.

Specifically, in the second embodiment, the grayscale image 140ₙ includes information for setting the intensity of light transmitted through pixels corresponding to the region R1ₙ among the plurality of pixels of the liquid crystal display 6 to intensity I1ₙ in the formation of the region R1ₙ. In addition, the grayscale image 140ₙ includes information for setting the intensity of light transmitted through pixels corresponding to the region R2, among the plurality of pixels of the liquid crystal display 6 to intensity I2ₙ in the formation of the region R2ₙ.

In the second embodiment, the intensity I1ₙ is equal to the intensity I1ₙ₋₁. The intensity I2ₙ is lower than the intensity I1ₙ. Here, the intensity I1ₙ is an example of first intensity. The intensity I2ₙ is an example of second intensity. As described above, a relationship of I2ₙ<I1ₙ is satisfied in the second embodiment.

In the example of FIG. 12B, the intensity I1ₙ is, for example, the intensity of the transmitted light in the case where the light transmittance of the pixel of the liquid crystal display 6 is 100%. The intensity I2ₙ is, for example, the intensity of the transmitted light in the case where the light transmittance of the pixel of the liquid crystal display 6 is 60%.

In addition, the grayscale image 140ₙ includes information for setting the intensity of light transmitted through pixels other than the pixels corresponding to the n-th layer (regions R1ₙ and R2ₙ) among the plurality of pixels of the liquid crystal display 6 to intensity IE.

The grayscale image 140ₙ₊₁ includes information for setting the intensity of the energy radiated by the light irradiation portion 5 in the formation of the region R1ₙ₊₁ to intensity I1ₙ₊₁. In addition, the grayscale image 140ₙ₊₁ includes information for setting the intensity of the energy radiated by the light irradiation portion 5 in the formation of the region R2ₙ₊₁ to intensity I2ₙ₊₁. In addition, the grayscale image 140ₙ₊₁ includes information for setting the intensity of the energy radiated by the light irradiation portion 5 in the formation of the region R3ₙ₊₁ to intensity I3ₙ₊₁.

Specifically, in the second embodiment, the grayscale image 140ₙ₊₁ includes information for setting the intensity of light transmitted through pixels corresponding to the region R1ₙ₊₁ among the plurality of pixels of the liquid crystal display 6 to intensity I1ₙ₊₁ in the formation of the region R1ₙ₊₁. In addition, the grayscale image 140ₙ₊₁ includes information for setting the intensity of light transmitted through pixels corresponding to the region R2ₙ₊₁ among the plurality of pixels of the liquid crystal display 6 to intensity I2ₙ₊₁ in the formation of the region R2ₙ₊₁. In addition, the grayscale image 140ₙ₊₁ includes information for setting the intensity of light transmitted through pixels corresponding to the region R3ₙ₊₁ among the plurality of pixels of the liquid crystal display 6 to intensity I3ₙ₊₁ in the formation of the region R3ₙ₊₁.

In the second embodiment, the intensity I1ₙ₊₁ is equal to the intensities I1ₙ₋₁ and I1ₙ. The intensity I2ₙ₊₁ is lower than the intensity I1ₙ₊₁. The intensity I3ₙ₊₁ is higher than the intensity I2ₙ₊₁. Here, the intensity I1ₙ₊₁ is an example of fourth intensity. The intensity I2ₙ₊₁ is an example of fifth intensity. The intensity I3ₙ₊₁ is an example of sixth intensity. As described above, in the second embodiment, a relationship of I3ₙ₊₁<I2ₙ₊₁<I1ₙ₊₁ is satisfied.

In addition, in the second embodiment, the intensity I2ₙ₊₁ is higher than the intensity I2ₙ. The intensity I3ₙ₊₁ is equal to the intensity I2ₙ.

In the example of FIG. 13A, the intensity I1ₙ₊₁ is, for example, the intensity of the transmitted light in the case where the light transmittance of the pixel of the liquid crystal display 6 is 100%. The intensity I2ₙ₊₁ is, for example, the intensity of the transmitted light in the case where the light transmittance of the pixel of the liquid crystal display 6 is 80%. The intensity I3ₙ₊₁ is, for example, the intensity of the transmitted light in the case where the light transmittance of the pixel of the liquid crystal display 6 is 60%.

In addition, the grayscale image 140ₙ₊₁ includes information for setting the intensity of light transmitted through pixels other than the pixels corresponding to the (n+1)-th layer (regions R1ₙ₊₁ to R3ₙ₊₁) among the plurality of pixels of the liquid crystal display 6 to intensity IE.

The grayscale image 140ₙ₊₂ includes information for setting the intensity of the energy radiated by the light irradiation portion 5 in the formation of the region R1ₙ₊₂ to intensity I1ₙ₊₂. In addition, the grayscale image 140ₙ₊₂ includes information for setting the intensity of the energy radiated by the light irradiation portion 5 in the formation of the region R2ₙ₊₂ to intensity I2ₙ₊₂. In addition, the grayscale image 140ₙ₊₂ includes information for setting the intensity of the energy radiated by the light irradiation portion 5 in the formation of the region R3ₙ₊₂ to intensity I3ₙ₊₂. In addition, the grayscale image 140ₙ₊₂ includes information for setting the intensity of the energy radiated by the light irradiation portion 5 in the formation of the region R4ₙ₊₂ to intensity I4ₙ₊₂.

Specifically, in the second embodiment, the grayscale image 140ₙ₊₂ includes information for setting the intensity of light transmitted through pixels corresponding to the region R1ₙ₊₂ among the plurality of pixels of the liquid crystal display 6 to intensity I1ₙ₊₂ in the formation of the region R1ₙ₊₂. In addition, the grayscale image 140ₙ₊₂ includes information for setting the intensity of light transmitted through pixels corresponding to the region R2ₙ₊₂ among the plurality of pixels of the liquid crystal display 6 to intensity I2ₙ₊₂ in the formation of the region R2ₙ₊₂. In addition, the grayscale image 140ₙ₊₂ includes information for setting the intensity of light transmitted through pixels corresponding to the region R3ₙ₊₂ among the plurality of pixels of the liquid crystal display 6 to intensity I3ₙ₊₂ in the formation of the region R3ₙ₊₂. In addition, the grayscale image 140ₙ₊₂ includes information for setting the intensity of light transmitted through pixels corresponding to the region R4ₙ₊₂ among the plurality of pixels of the liquid crystal display 6 to intensity I4ₙ₊₂ in the formation of the region R4ₙ₊₂.

In the second embodiment, the intensity I1ₙ₊₂ is equal to the intensities I1ₙ₋₁ to I1ₙ₊₁. The intensity I2ₙ₊₂ is equal to the intensity I1ₙ₊₂. The intensity I3ₙ₊₂ is lower than the intensity I2ₙ₊₂. The intensity I4ₙ₊₂ is lower than the intensity I3ₙ₊₂. As described above, in the second embodiment, a relationship of I4ₙ₊₂<I3ₙ₊₂<I2ₙ₊₂≤I1ₙ₊₂ is satisfied.

In addition, in the second embodiment, the intensity I2ₙ₊₂ is higher than the intensity I2ₙ₊₁. The intensity I3ₙ₊₂ is higher than the intensity I3ₙ₊₁. The intensity I4ₙ₊₂ is equal to the intensity I3ₙ₊₁. The intensity I3ₙ₊₂ is equal to the intensity I2ₙ₊₁.

In the example of FIG. 13B, the intensities I1ₙ₊₂ and I2ₙ₊₂ are each, for example, the intensity of the transmitted light in the case where the light transmittance of the pixel of the liquid crystal display 6 is 100%. The intensity I3ₙ₊₂ is, for example, the intensity of the transmitted light in the case where the light transmittance of the pixel of the liquid crystal display 6 is 80%. The intensity I4ₙ₊₂ is, for example, the intensity of the transmitted light in the case where the light transmittance of the pixel of the liquid crystal display 6 is 60%.

In addition, the grayscale image 140ₙ₊₂ includes information for setting the intensity of light transmitted through pixels other than the pixels corresponding to the (n+2)-th layer (regions R1ₙ₊₂ to R4ₙ₊₂) among the plurality of pixels of the liquid crystal display 6 to intensity IE.

As described above, in the grayscale image 140ₙ₋₁ not including a pixel corresponding to the overhang portion 23A, the pixels corresponding to the shaped object is expressed by white, and in the grayscale images 140 to 140ₙ₊₂ including a pixel corresponding to the overhang portion 23A, the pixels corresponding to the shaped object are expressed by either white or gray.

The setting information 220 generated as described above is transmitted to the control apparatus 200, and the shaped object 20A is manufactured in the shaping apparatus 100. The manufacturing method for the shaped object 20A in the second embodiment is substantially the same as in the first embodiment.

In the formation of the n-th layer including the overhang surface 24A, the grayscale image 140ₙ illustrated in FIG. 12B is displayed on the liquid crystal display 6. In the second embodiment, since the intensity of the light 10 radiated onto the region R2, corresponding to the overhang portion 23A is lower than the intensity of the light 10 radiated onto the region R1ₙ corresponding to the base portion 22A, the amount of light transmitted to the photocurable resin composition 1 of a layer higher than the n-th layer is reduced. As a result of the intensity of light emitted from the liquid crystal display 6 being adjusted for each pixel, formation of the excess shaped portion on the overhang portion 23A can be prevented or suppressed, and therefore the shaped object 20A, that is, the shaped product 21A having a highly precise shape close to the three-dimensional shape model can be obtained, and the post-processing for adjusting the shape of the shaped product 21A can be reduced, or removal of the shaped product 21A as a defected product can be suppressed. Therefore, the manufacturing cost of the shaped product 21A can be reduced.

In the formation of the (n+1)-th layer subsequent to the n-th layer, the grayscale image 140ₙ₊₁ illustrated in FIG. 13A is displayed on the liquid crystal display 6. In the second embodiment, since the intensity of the light 10 radiated onto the regions R2ₙ₊₁ and R3ₙ₊₁ corresponding to the overhang portion 23A from the liquid crystal display 6 is lower than the intensity of the light 10 radiated onto the region R1ₙ₊₁ corresponding to the base portion 22A from the liquid crystal display 6, the amount of light transmitted to a position higher than the n−+1 layer is reduced. As a result of this, formation of the excess shaped portion on the overhang portion 23A can be prevented or suppressed, and therefore the shaped object 20A, that is, the shaped product 21A having a highly precise shape close to the three-dimensional shape model can be obtained, and the post-processing for adjusting the shape of the shaped product 21A can be reduced, or removal of the shaped product 21A as a defected product can be suppressed. Therefore, the manufacturing cost of the shaped product 21A can be reduced.

In addition, when forming the (n+1)-th layer, since the region R2, of the n-th layer has been already formed, diffused reflection of light can occur at a corner portion of the region R2ₙ. Particularly, the region R3ₙ₊₁ is a region continuous with the region R2ₙ₊₁, and is close to the corner portion of the region R2ₙ, and therefore the diffused reflection light is more influential therein, and the n-th layer is not present thereon. Therefore, the intensity I3ₙ₊₁ of light for forming the region R3ₙ₊₁ of the (n+1)-th layer is preferably lower than the intensity I1ₙ₊₁, and is set to, for example, intensity equal to the intensity I2ₙ. In addition, the region R2ₙ₊₁ is influenced by the diffused reflection light occurring at the corner portion of the region R2, although not as much as the region R3ₙ₊₁. Therefore, in consideration of the diffused reflection light generated at the corner portion of the region R2ₙ, it is preferable that the intensity I2ₙ₊₁ is higher than the intensities I2ₙ and I3ₙ₊₁ and lower than the intensity I1ₙ₊₁. As a result of this, formation of the excess shaped portion on the overhang portion 23A can be prevented or suppressed, and therefore the shaped object 20A, that is, the shaped product 21A having a highly precise shape close to the three-dimensional shape model can be obtained, and the post-processing for adjusting the shape of the shaped product 21A can be reduced, or removal of the shaped product 21A as a defected product can be suppressed. Therefore, the manufacturing cost of the shaped product 21A can be reduced.

### Third Embodiment

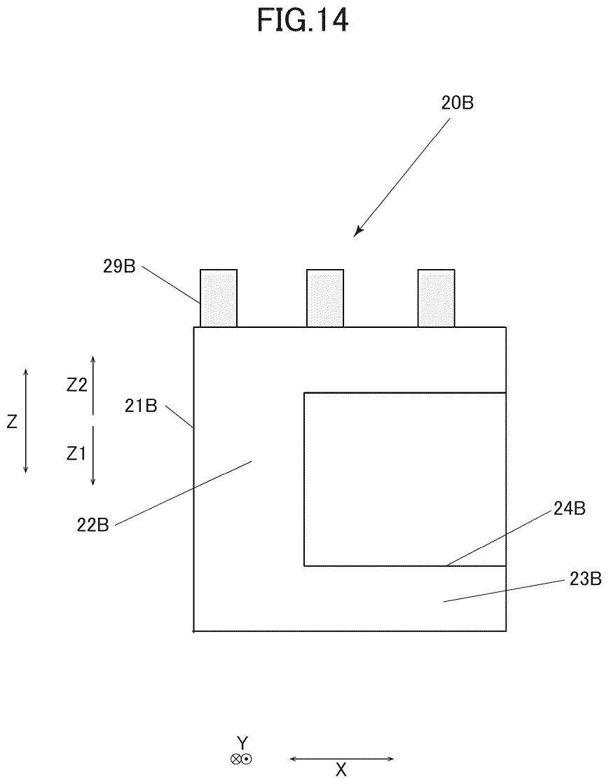

A third embodiment will be described. In the third embodiment, description of elements common to the first and second embodiments will be simplified or omitted. FIG. 14 is a schematic view of a shaped object 20B according to the third embodiment. In the third embodiment, the shape of the shaped object 20B to be formed is different from the shape of the shaped objects 20 and 20A of the first and second embodiments. The shaped object 20B of the third embodiment includes a shaped product 21B and supports 29B. The shaped product 21B includes a base portion 22B and an overhang portion 23B. In the third embodiment, a wall portion serving as the base portion 22B is also provided in the Y direction, that is, the depth direction. That is, the overhang portion 23B projects in the X direction and the Y direction with respect to the base portion 22B. An overhang surface 24B of the overhang portion 23B is a surface extending in the X direction and the Y direction. The configuration of the shaping system of the third embodiment is substantially the same as the configuration of the shaping system 1000 of the first embodiment.

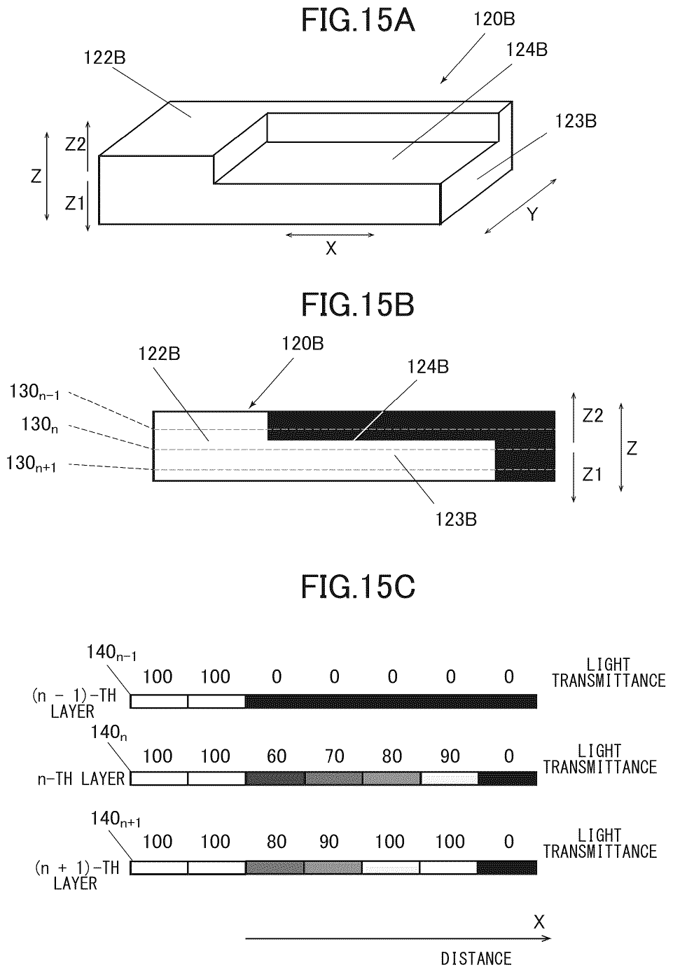

FIGS. 15A to 15C are each an explanatory diagram of information processing according to the third embodiment. FIG. 15A is a perspective view schematically illustrating part of a three-dimensional shape model 120B corresponding to the shaped object 20B as a three-dimensional image. The information processing portion 620 slices the three-dimensional shape model 120B illustrated in FIG. 15A and obtains slice images 130ₙ₋₁, 130ₙ, and 130ₙ₊₁ illustrated in FIG. 15B, where n is an integer of 2 or more.

Here, the three-dimensional shape model 120B includes a portion 122B corresponding to the base portion 22B and a portion 123B corresponding to the overhang portion 23B. The portion 123B includes a portion 124B corresponding to the overhang surface 24B.

To be noted, the processing illustrated in FIGS. 15A to 15C is approximately the same as the processing of the first embodiment illustrated in FIGS. 6A to 6C, and therefore the description thereof will be omitted.

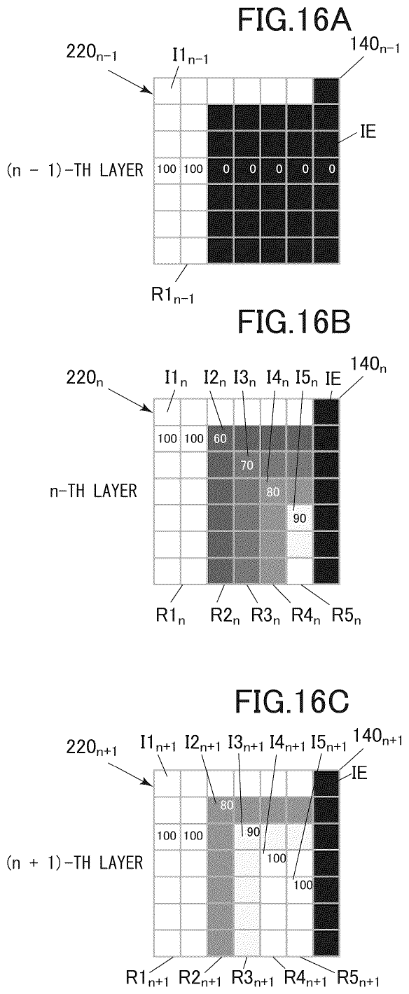

FIGS. 16A to 16C are each an explanatory diagram of the information processing according to the third embodiment. One pixel of the grayscale image corresponds to one pixel of the liquid crystal display 6. In the example of FIGS. 16A to 16C, the grayscale images 140ₙ₋₁, 140ₙ, and 140ₙ₊₁, each include, for example, 7×7=49 pixels. To be noted, the number of pixels is an example used for the sake of convenience of description, and is not limited to this. In addition, one pixel of the grayscale image may correspond to two or more pixels, for example, 2×2=4 pixels of the liquid crystal display 6.

FIG. 16A is an explanatory diagram of setting information 220ₙ₋₁ used for the formation of the (n−1)-th layer according to the third embodiment. FIG. 16B is an explanatory diagram of setting information 220ₙ used for the formation of the n-th layer according to the third embodiment. FIG. 16C is an explanatory diagram of setting information 220ₙ₊₁ used for the formation of the (n+1)-th layer according to the third embodiment. The setting information 220 includes the setting information 220ₙ₋₁, the setting information 220ₙ, and the setting information 220ₙ₊₁.

In the third embodiment, the setting information 220ₙ₋₁ to 220ₙ₊₁ respectively include the grayscale images 140ₙ₋₁ to 140ₙ₊₁ to be displayed on the liquid crystal display 6. The grayscale images 140ₙ₋₁ to 140ₙ₊₁ are image information (image data). To be noted, FIGS. 16A to 16C schematically illustrate layers of the shaped object and the grayscale images 140ₙ₋₁ to 140ₙ₊₁ in association with each other for the sake of convenience of description. To be noted, the processing illustrated in FIGS. 16A to 16C is approximately the same as the processing of the first embodiment illustrated in FIGS. 7A to 7C. Therefore, description of common matter will be omitted, and different matter will be described below.

The (n−1)-th layer includes a region R1ₙ₋₁ corresponding to the base portion 22B. The region R1ₙ₋₁ is an L-shaped region, and corresponds to 18 pixels in the grayscale image 140ₙ₋₁, that is, on the liquid crystal display 6.

The n-th layer includes a region R1ₙ overlapping with the (n−1)-th layer, that is, the region R1ₙ₋₁ in the Z1 direction. The region R1ₙ is an L-shaped region, and corresponds to 18 pixels in the grayscale image 140ₙ, that is, on the liquid crystal display 6.

In addition, the n-th layer includes a region R2ₙ that is continuous with the region R1ₙ and does not overlap with the (n−1)-th layer, that is, the region R1ₙ₋₁ in the Z1 direction. The region R2ₙ is an L-shaped region, and corresponds to 9 pixels in the grayscale image 140ₙ, that is, on the liquid crystal display 6.

In addition, the n-th layer includes a region R3ₙ that is continuous with the region R2ₙ and does not overlap with the (n−1)-th layer, that is, the region R1ₙ₋₁ in the Z1 direction. The region R3ₙ is an L-shaped region, and corresponds to 7 pixels in the grayscale image 140ₙ, that is, on the liquid crystal display 6. The minimum distance from the region R1ₙ to the region R3ₙ is larger than the minimum distance from the region R1ₙ to the region R2ₙ. That is, the region R3ₙ is farther away from the region R1ₙ than the region R2ₙ.

In addition, the n-th layer includes a region R4ₙ that is continuous with the region R3ₙ and does not overlap with the (n−1)-th layer, that is, the region R1ₙ₋₁ in the Z1 direction. The region R4ₙ is an L-shaped region, and corresponds to 5 pixels in the grayscale image 140ₙ, that is, on the liquid crystal display 6. The minimum distance from the region R1ₙ to the region R4, is larger than the minimum distance from the region R1ₙ to the region R3ₙ. That is, the region R4, is farther away from the region R1ₙ than the region R3ₙ.

In addition, the n-th layer includes a region R5ₙ that is continuous with the region R4ₙ and does not overlap with the (n−1)-th layer, that is, the region R1ₙ₋₁ in the Z1 direction. The region R5ₙ is an I-shaped region, and corresponds to 3 pixels in the grayscale image 140ₙ, that is, on the liquid crystal display 6. The minimum distance from the region R1ₙ to the region R5ₙ is larger than the minimum distance from the region R1ₙ to the region R4ₙ. That is, the region R5ₙ is farther away from the region R1ₙ than the region R4ₙ.

Here, the region R1ₙ is an example of a first region. The region R2, is an example of a second region. The region R3ₙ is an example of a third region. The region R1ₙ corresponds to the base portion 22B, and the regions R2ₙ to R5ₙ correspond to the overhang portion 23B (overhang surface 24B).

The (n+1)-th layer includes a region R1ₙ₊₁ overlapping with the region R1ₙ in the Z1 direction. The region R1ₙ₊₁ is an L-shaped region, and corresponds to 18 pixels in the grayscale image 140ₙ₊₁, that is, on the liquid crystal display 6. The region R1ₙ₊₁ does not overlap with the regions R2ₙ to R5ₙ in the Z1 direction.

In addition, the (n+1)-th layer includes a region R2ₙ₊₁ that is continuous with the region R1ₙ₊₁ and overlaps with the region R2ₙ in the Z1 direction. The region R2ₙ₊₁ is an L-shaped region, and corresponds to 9 pixels in the grayscale image 140ₙ₊₁, that is, on the liquid crystal display 6. The region R2ₙ₊₁ does not overlap with the regions R1ₙ and R3ₙ to R5ₙ in the Z1 direction.

In addition, the (n+1)-th layer includes a region R3ₙ₊₁ that is continuous with the region R2ₙ₊₁ and overlaps with the region R3ₙ in the Z1 direction. The region R3ₙ₊₁ is an L-shaped region, and corresponds to 7 pixels in the grayscale image 140ₙ₊₁, that is, on the liquid crystal display 6. The region R3ₙ₊₁ does not overlap with the regions R1ₙ, R2ₙ, R4ₙ, and R5ₙ in the Z1 direction. The minimum distance from the region R1ₙ₊₁ to the region R3ₙ₊₁ is larger than the minimum distance from the region R1ₙ₊₁ to the region R2ₙ₊₁. That is, the region R3ₙ₊₁ is farther away from the region R1ₙ₊₁ than the region R2ₙ₊₁.

In addition, the (n+1)-th layer includes a region R4ₙ₊₁ that is continuous with the region R3ₙ₊₁ and overlaps with the region R4ₙ in the Z1 direction. The region R4ₙ₊₁ is an L-shaped region, and corresponds to 5 pixels in the grayscale image 140ₙ₊₁, that is, on the liquid crystal display 6. The region R4ₙ₊₁ does not overlap with the regions R1ₙ to R3ₙ and R5ₙ in the Z1 direction. The minimum distance from the region R1ₙ₊₁ to the region R4ₙ₊₁ is larger than the minimum distance from the region R1ₙ₊₁ to the region R3ₙ₊₁. That is, the region R4ₙ₊₁ is farther away from the region R1ₙ₊₁ than the region R3ₙ₊₁.

In addition, the (n+1)-th layer includes a region R5ₙ₊₁ that is continuous with the region R4ₙ₊₁ and overlaps with the region R5ₙ in the Z1 direction. The region R5ₙ₊₁ is an I-shaped region, and corresponds to 3 pixels in the grayscale image 140ₙ₊₁, that is, on the liquid crystal display 6. The region R5ₙ₊₁ does not overlap with the regions R1ₙ to R4ₙ in the Z1 direction. The minimum distance from the region R1ₙ₊₁ to the region R5ₙ₊₁ is larger than the minimum distance from the region R1ₙ₊₁ to the region R4ₙ₊₁. That is, the region R5ₙ₊₁ is farther away from the region R1ₙ₊₁ than the region R4ₙ₊₁.

Here, the region R1ₙ₊₁ is an example of a fourth region. The region R2ₙ₊₁ is an example of a fifth region. The region R3ₙ₊₁ is an example of a sixth region. The region R1ₙ₊₁ corresponds to the base portion 22B, and the regions R2ₙ₊₁ to R5ₙ₊₁ correspond to the overhang portion 23B.

In the third embodiment, the intensity I1ₙ is equal to the intensity I1ₙ₋₁. The intensity I2ₙ is lower than the intensity I1ₙ. The intensity I3ₙ is higher than the intensity I2ₙ. The intensity I4ₙ is higher than the intensity I3ₙ. The intensity I5ₙ is higher than the intensity I4ₙ. In addition, the intensities I3ₙ to I5ₙ are lower than the intensity I1ₙ. Here, the intensity I1ₙ is an example of first intensity. The intensity I2ₙ is an example of second intensity. The intensity I3ₙ is an example of third intensity.

As described above, in the third embodiment, a relationship of I2ₙ<I3ₙ<I4ₙ<I5ₙ<I1ₙ is satisfied. To be noted, as a modification example, a relationship of I2ₙ<I3ₙ<I4ₙ<I5ₙ≤I1ₙ may be satisfied. That is, the intensity I5ₙ may be equal to or lower than the intensity I1ₙ. In addition, as another modification example, a relationship of I2ₙ<I3ₙ<I4ₙ≤I5ₙ<I1ₙ may be satisfied. That is, the intensities I4ₙ and I5ₙ may be equal to or lower than the intensity I1ₙ. In addition, as yet another modification example, a relationship of I2ₙ<I3ₙ≤I4ₙ≤I5ₙ≤I1ₙ may be satisfied. That is, the intensities I3ₙ to I5ₙ may be equal to or lower than the intensity I1ₙ.

In addition, the region R5ₙ may be omitted. In addition, the regions R4, and R5ₙ may be omitted. In addition, the regions R3ₙ to R5ₙ may be omitted.

In addition, in the third embodiment, the intensity I1ₙ₊₁ is equal to the intensities I1ₙ₋₁ and I1ₙ. The intensity I2ₙ₊₁ is lower than the intensity I1ₙ₊₁. The intensity I3ₙ₊₁ is higher than the intensity I2ₙ₊₁. The intensities I4ₙ₊₁ and I5ₙ₊₁ are higher than the intensity I3ₙ₊₁. In addition, the intensity I3ₙ₊₁ is lower than the intensity I1ₙ₊₁. The intensities I4ₙ₊₁ and I5ₙ₊₁ are equal to the intensities I1ₙ₋₁ and I1ₙ. Here, the intensity I1ₙ₊₁ is an example of fourth intensity. The intensity I2ₙ₊₁ is an example of fifth intensity. The intensity I3ₙ₊₁ is an example of sixth intensity.

As described above, in the third embodiment, a relationship of I2ₙ₊₁<I3ₙ₊₁<I4ₙ₊₁<I5ₙ₊₁≤I1ₙ₊₁ is satisfied. That is, the intensities I4ₙ₊₁ and I5ₙ₊₁ are equal to or lower than the intensity I1ₙ₊₁. To be noted, as a modification example, a relationship of I2ₙ₊₁<I3ₙ₊₁<I4ₙ₊₁<I5ₙ₊₁<I1ₙ₊₁ may be satisfied. In addition, as another modification example, a relationship of I2ₙ₊₁<I3ₙ₊₁<I4ₙ₊₁<I5ₙ₊₁<I1ₙ₊₁ may be satisfied. That is, the intensity I5ₙ₊₁ may be equal to or lower than the intensity I1ₙ₊₁. In addition, as yet another modification example, a relationship of I2ₙ₊₁<I3ₙ₊₁≤I4ₙ₊₁≤I5ₙ₊₁<I1ₙ₊₁ may be satisfied. That is, the intensities I3ₙ₊₁ to I5ₙ₊₁ may be equal to or lower than the intensity I1ₙ₊₁.

In addition, in the third embodiment, the intensity I2ₙ₊₁ is higher than the intensity I2ₙ. The intensity I2ₙ₊₁ is higher than the intensity I3ₙ. The intensity I2ₙ₊₁ is equal to the intensity I4ₙ. In addition, in the third embodiment, the intensity I3ₙ₊₁ is higher than the intensity I3ₙ. The intensity I3ₙ₊₁ is higher than the intensity I4ₙ. The intensity I3ₙ₊₁ is equal to the intensity I5ₙ. In addition, in the third embodiment, the intensity I4ₙ₊₁ is higher than the intensity I4ₙ. The intensity I4ₙ₊₁ is higher than the intensity I5ₙ. In addition, in the third embodiment, the intensity I5ₙ₊₁ is higher than the intensity I5ₙ.

In addition, the region R5ₙ₊₁ may be omitted. In addition, the regions R4ₙ₊₁ and R5ₙ₊₁ may be omitted. In addition, the regions R3ₙ₊₁ to R5ₙ₊₁ may be omitted.

Here, in the formation of the n-th layer including the overhang surface 24B, the grayscale image 140ₙ illustrated in FIG. 16B is displayed on the liquid crystal display 6. In the third embodiment, since the intensity of the light 10 radiated onto the regions R2ₙ to R5ₙ corresponding to the overhang portion 23B is lower than the intensity of the light 10 radiated onto the region R1ₙ corresponding to the base portion 22B, the amount of light transmitted to the photocurable resin composition 1 of a layer higher than the n-th layer is reduced. As a result of the intensity of light emitted from the liquid crystal display 6 being adjusted for each pixel, formation of the excess shaped portion on the overhang portion 23B can be prevented or suppressed, and therefore the shaped object 20B, that is, the shaped product 21B having a highly precise shape close to the three-dimensional shape model can be obtained, and the post-processing for adjusting the shape of the shaped product 21B can be reduced, or removal of the shaped product 21B as a defected product can be suppressed. Therefore, the manufacturing cost of the shaped product 21B can be reduced.

In addition, the intensity of the diffused reflection light at the corner portion of an already-shaped portion of the base portion 22B, for example, the corner portion of the region R1ₙ₋₁ is higher as the region is closer to the region R1ₙ. Particularly, in the region R2ₙ, the diffused reflection light is more influential because the region R2ₙ is a region continuous with the region R1ₙ and is close to the region R1ₙ₋₁. In the third embodiment, the intensity of light radiated from the liquid crystal display 6 decreases stepwise as the region is closer to the region R1ₙ. Specifically, the light intensity is set to satisfy a relationship of I2ₙ<I3ₙ<I4ₙ<I5ₙ<I1ₙ. Particularly, the amount of light transmitted to the photocurable resin composition 1 in the region R2ₙ or higher is reduced. As a result of this, the intensity distribution of the light radiated onto the regions R2ₙ to R5ₙ is substantially equalized. As a result of this, the formation of the excess shaped portion on the overhang portion 23B is prevented or suppressed, and therefore the shaped object 20B, that is, the shaped product 21B having a more highly precise shape can be obtained. To be noted, since the diffused reflection light is less influential as the region is farther away from the region R1ₙ in the X direction, the intensity of the transmitted light of the liquid crystal display 6 may be set to I5ₙ=I1ₙ, 14ₙ=I5ₙ=I1ₙ, or I3ₙ=I4ₙ=I5ₙ=I1ₙ.

In the formation of the (n+1)-th layer subsequent to the n-th layer, the grayscale image 140ₙ₊₁ illustrated in FIG. 16C is displayed on the liquid crystal display 6. In the third embodiment, since the intensity of the light 10 radiated onto the regions R2ₙ₊₁ and R3ₙ₊₁ corresponding to the overhang portion 23B from the liquid crystal display 6 is lower than the intensity of the light 10 radiated onto the region R1ₙ₊₁ corresponding to the base portion 22B from the liquid crystal display 6, the amount of light transmitted to a position higher than the (n+1)-th layer is reduced. As a result of this, formation of the excess shaped portion on the overhang portion 23B can be prevented or suppressed, and therefore the shaped object 20B, that is, the shaped product 21B having a highly precise shape close to the three-dimensional shape model can be obtained, and the post-processing for adjusting the shape of the shaped product 21B can be reduced, or removal of the shaped product 21B as a defected product can be suppressed. Therefore, the manufacturing cost of the shaped product 21B can be reduced.

In addition, when forming the (n+1)-th layer, since the n-th layer has been already formed, a portion where diffused reflection of light is likely to occur, for example, the corner portion of the region R1ₙ₋₁ of the (n−1)-th layer is surrounded by the n-th layer. Therefore, the intensity of light reaching the portion where the diffused reflection of light is likely to occur is reduced. That is, the occurrence of diffused reflection light is reduced, and therefore the intensity of the light 10 radiated from the liquid crystal display 6 can be made closer to I1ₙ₊₁. Therefore, the light intensities I2ₙ₊₁ to I5ₙ₊₁ for forming the regions R2ₙ₊₁ to R5ₙ₊₁ of the (n+1)-th layer may be respectively higher than the intensities I2ₙ to I5ₙ for forming the regions R2, to R5ₙ of the n-th layer. Specifically, I2ₙ₊₁>I2ₙ, I3ₙ₊₁>I3ₙ, I4ₙ₊₁>I4ₙ, and I5ₙ₊₁>I5ₙ are set. As a result of this, the (n+1)-th layer can be efficiently cured. In addition, since the intensity of the light used for curing the (n+1)-th layer is made higher than the intensity of the light used for curing the n-th layer, light attenuated by the (n+1)-th layer can reach the n-th layer, but curing of the n-th layer can be promoted by this attenuated light. As a result of this, the n-th layer can be also efficiently cured.

### Examples

Examples 1 to 3 corresponding to the first to third embodiments described above and Comparative Example 1 corresponding to a comparative example will be described below.

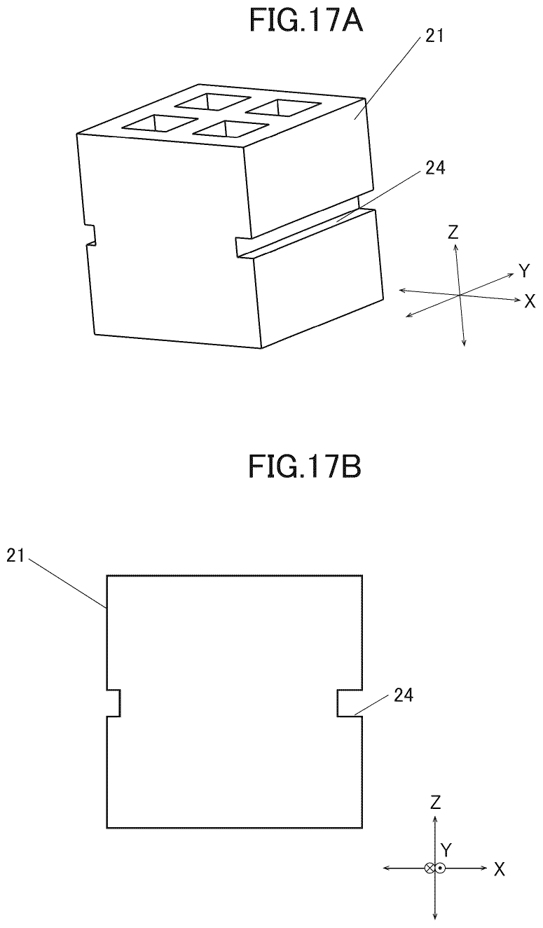

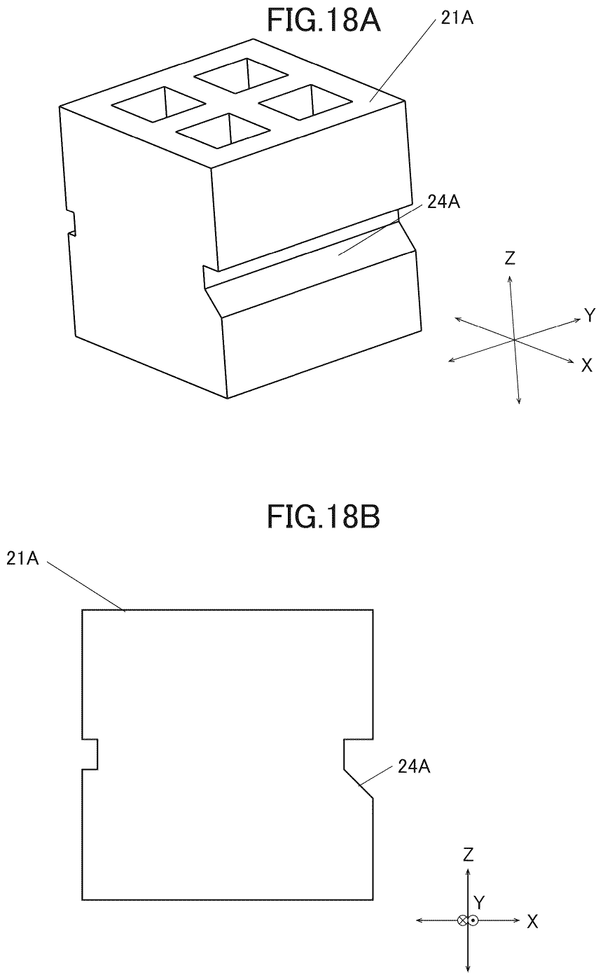

Shaped products of Examples 1 to 3 and Comparative Example 1 were manufactured by using the shaping apparatus 100 illustrated in FIG. 1 in an environment of about 25° C. FIG. 17A is a perspective view of the shaped product 21 of Example 1. FIG. 17B is a section view of the shaped product 21 of Example 1. FIG. 18A is a perspective view of the shaped product 21A of Example 2. FIG. 18B is a section view of the shaped product 21A of Example 2. The size of the outer shape (convex hull shape) of the shaped products 21 and 21A was set to a width of 10 mm, a depth of 10 mm, and a height of 10 mm.

The overhang surface 24 illustrated in FIGS. 17A and 17B is a flat surface extending in a direction orthogonal to the lamination direction. The overhang surface 24A illustrated in FIGS. 18A and 18B is an inclined surface extending in a direction inclined with respect to the lamination direction.

The size of the shaping stage 3 was 192 mm×120 mm. An acrylic material was used as the photocurable resin composition 1 serving as a shaping material. Ultraviolet light having a wavelength of 405 nm was used as the light of the light source 8. The average intensity of the light of the light source 8 was set to 2.8 mW/cm². The size of the container 2 was about 220 mm×190 mm×30 mm. An image having a resolution of 3840 pixels×2400 pixels was set as the image to be displayed on the liquid crystal display 6.

A grayscale image of 256 gradation levels was set as the image to be displayed on the liquid crystal display 6 in Examples 1 to 3. In the formation of the shaped product of Comparative Example 1, a three-dimensional shape model corresponding to the shaped product of Example 1 was used. The image displayed on the liquid crystal display 6 in Comparative Example 1 was an image of 2 gradation levels (black and white) instead of a grayscale image of 256 gradation levels.

The shaping condition was set as follows: the thickness Δt per layer was set to 50 μm; the irradiation time of ultraviolet light per layer was set to 2.46 seconds; and the lifting amount of the shaping stage 3 was set to 3 mm. After the completion of shaping, the supports were removed from the shaped product.

The shaped product from which the supports were removed was cleaned with ethanol to remove an excess resin liquid attaching to the shaped product, and then the shaped product was dried for 20 minutes in a draft chamber. Then, the cross-section of the shaped product was observed by using a computer numerical control (CNC) image measurement machine, and thus the excess curing amount on the overhang surface was measured and evaluated.

In Examples 1 to 3 and Comparative Example 1, evaluation was made in the following three levels.
A: A desired overhang shape was obtained.
B: Protrusion was observed in part of the overhang surface.
C: Shaping defect.

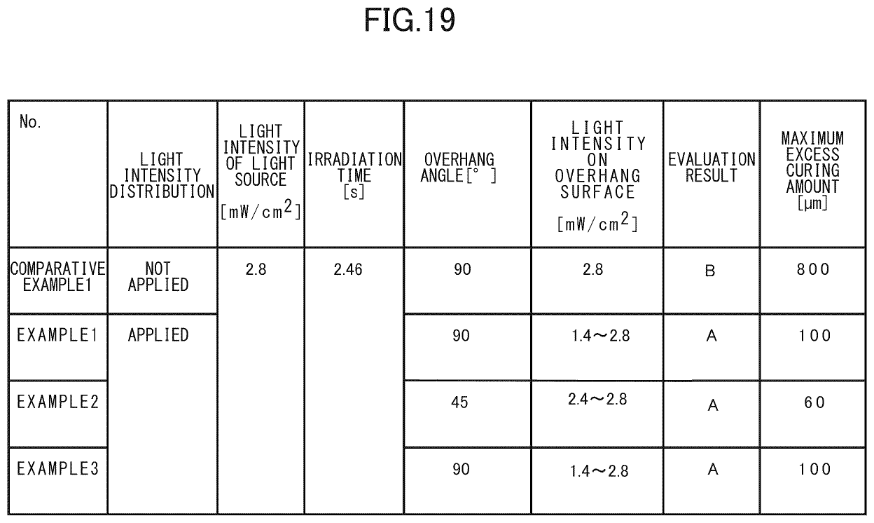

FIG. 19 illustrates the evaluation results. Here, the overhang angle is the angle of the overhang surface with respect to the lamination direction, and was set to 90° in Examples 1 and 3 and Comparative Example 1, and 45° in Example 2.

In the case of Comparative Example 1, an excess shaped portion having a protruding shape with respect to the shape of the model was formed on the overhang surface when it was attempted to cure the overhang surface at a uniform light intensity. Regarding the height (excess curing amount) of the excess shaped portion in the Z direction with respect to the overhang surface in design in Comparative Example 1, the minimum value was 20 μm, and the maximum value was 800 μm.

In Example 1, in the case of forming the overhang surface by exposure to light, the curing was performed by setting the light intensity distribution in the overhang surface in a range from 1.4 to 2.8. In Example 1, regarding the height (excess curing amount) of the excess shaped portion in the Z direction with respect to the overhang surface in design, the minimum value was 0, and the maximum value was 100 μm. As described above, regarding the shaped product 21 of Example 1, no shaping defect was observed, and the shape precision was high.

In Example 2, in the case of forming the overhang surface by exposure to light, the curing was performed by setting the light intensity distribution in the overhang surface in a range from 2.4 to 2.8. In Example 2, regarding the height (excess curing amount) of the excess shaped portion in the Z direction with respect to the overhang surface in design, the minimum value was 0, and the maximum value was 60 μm. As described above, regarding the shaped product 21A of Example 2, no shaping defect was observed, and the shape precision was high.

In Example 3, in the case of forming the overhang surface by exposure to light, the curing was performed by setting the light intensity distribution in the overhang surface in a range from 1.4 to 2.8. In Example 3, regarding the height (excess curing amount) of the excess shaped portion in the Z direction with respect to the overhang surface in design, the minimum value was 0, and the maximum value was 100 μm. As described above, regarding the shaped product of Example 3, no shaping defect was observed, and the shape precision was high.

According to the present disclosure, an apparatus or method that improves the precision of the shaped object can be provided.

The present disclosure is not limited to the embodiments described above, and the embodiments can be modified in many ways within the technical concept of the present disclosure. In addition, the effects described in the present embodiment are merely enumeration of the most preferable effects that can be obtained from the embodiments of the present disclosure, and the effects of the embodiments of the present disclosure are not limited to those described in the present embodiment.

In the first to third embodiments, the light irradiation method is the still image method, and the light source 8 is turned on and off each time a grayscale image displayed on the liquid crystal display 6 is switched, but the configuration is not limited to this. Depending on the properties of the photocurable resin composition 1 such as the material and viscosity, a moving image may be displayed on the liquid crystal display 6 in a state in which the light source 8 is on, and thus the photocurable resin composition 1 in the container 2 may be planarly irradiated with light continuously.

In addition, in the first to third embodiments, a case where the host apparatus 610 and the information processing apparatus 300 are each constituted by a different computer has been described, but the configuration is not limited to this, and for example, these may be constituted by a single computer.

In addition, the information processing apparatus 300 may be incorporated in the shaping apparatus, and in this case, the information processing apparatus 300 may have the function of the control apparatus 200.

In addition, although a case where the liquid crystal display 6 requiring backlight has been described in the first to third embodiments, the configuration is not limited to this. For example, in the case where a display which emits light itself and in which the light intensity can be adjusted for each pixel, such as a plasma display or an organic electroluminescence display is used, the display may be used instead of the irradiation portion and the liquid crystal display.

In addition, although a case where a lifting method in which the shaped layer is formed by radiating light from below the container and lifting the shaping stage is employed as the optical shaping method has been described in the first to third embodiments, the configuration is not limited to this. For example, a lowering method in which the shaped layer is formed by radiating light from above the container and lowering the shaping stage may be employed.

In addition, although a case of the LCD method among the optical shaping methods has been described in the first to third embodiments, the configuration is not limited to this. Among the optical shaping methods, a method different from the LCD method, such as the SLA method or the DLP method may be employed. In addition, instead of the optical shaping method, for example, a powder sintering method in which a layer is shaped by sintering powder serving as the shaping material with laser light may be employed. In addition, although a case where the photocurable resin composition 1 is the shaping material has been described, the configuration is not limited to this. In the case of the powder sintering method, for example, a metal powder or a ceramic powder can be used as the shaping material.

Further, what is disclosed in the present specification is not limited to what is explicitly described in the present specification, and includes all the matter that can be grasped from the present specification and drawings attached to the present specification. In addition, what is disclosed in the present specification includes complementary sets of individual concepts described in the present specification. That is, for example, if description of “A is B” is included in the present specification, it can be said that the present specification discloses a concept of “A is not B” even if description of “A is not B” is omitted. This is because the description of “A is B” is included on the premise that a case where “A is not B” has been also considered.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-062787, filed Apr. 7, 2023, which is hereby incorporated by reference herein in its entirety.

What is claimed is:

1. An information processing apparatus used for a shaping apparatus configured to form a shaped object including a plurality of layers laminated on each other, the information processing apparatus comprising:
an information processing portion,
wherein the information processing portion is configured to obtain setting information set for the shaping apparatus for causing the shaping apparatus to form the plurality of layers,
wherein the plurality of layers include an (n−1)-th layer (n is an integer of 2 or more), and an n-th layer formed subsequently to the (n−1)-th layer,
wherein the n-th layer includes a first region overlapping with the (n−1)-th layer in a lamination direction, and a second region that is continuous with the first region and that does not overlap with the (n−1)-th layer in the lamination direction, and
wherein the setting information includes information for setting an energy radiated by an irradiation portion of the shaping apparatus in formation of the first region to first intensity, and
information for setting the energy radiated by the irradiation portion in formation of the second region to second intensity lower than the first intensity.

2. The information processing apparatus according to claim 1,
wherein the n-th layer includes a third region that is continuous with the second region and that does not overlap with the (n−1)-th layer in the lamination direction, and
wherein the setting information includes information for setting the energy radiated by the irradiation portion in formation of the third region to third intensity higher than the second intensity.

3. The information processing apparatus according to claim 2, wherein the third intensity is equal to or lower than the first intensity.

4. The information processing apparatus according to claim 1,
wherein the plurality of layers include an (n+1)-th layer formed subsequently to the n-th layer, and
wherein the (n+1)-th layer includes
a fourth region that overlaps with the first region in the lamination direction, and
a fifth region that is continuous with the fourth region and that overlaps with the second region in the lamination direction, and
wherein the setting information includes
information for setting the energy radiated by the irradiation portion in formation of the fourth region to fourth intensity, and
information for setting the energy radiated by the irradiation portion in formation of the fifth region to fifth intensity lower than the fourth intensity.

5. The information processing apparatus according to claim 4, wherein the fifth intensity is higher than the second intensity.

6. The information processing apparatus according to claim 2,
wherein the plurality of layers include an (n+1)-th layer formed subsequently to the n-th layer, and
wherein the (n+1)-th layer includes
a fourth region that overlaps with the first region in the lamination direction,
a fifth region that is continuous with the fourth region and that overlaps with the second region in the lamination direction, and
a sixth region that is continuous with the fifth region and that overlaps with the third region in the lamination direction, and
wherein the setting information includes
information for setting the energy radiated by the irradiation portion in formation of the fourth region to fourth intensity,
information for setting the energy radiated by the irradiation portion in formation of the fifth region to fifth intensity lower than the fourth intensity, and
information for setting the energy radiated by the irradiation portion in formation of the sixth region to sixth intensity equal to or lower than the fourth intensity and higher than the fifth intensity.

7. The information processing apparatus according to claim 6, wherein the fifth intensity is higher than the second intensity, and/or
wherein the sixth intensity is higher than the third intensity, and/or
wherein the fifth intensity is higher than the third intensity.

8. The information processing apparatus according to claim 2,
wherein the plurality of layers include an (n+1)-th layer formed subsequently to the n-th layer, and
wherein the (n+1)-th layer includes
a fourth region that overlaps with the first region in the lamination direction,
a fifth region that is continuous with the fourth region and that overlaps with the second region in the lamination direction, and
a sixth region that is continuous with the fifth region and that does not overlap with the n-th layer in the lamination direction, and
wherein the setting information includes
information for setting the energy radiated by the irradiation portion in formation of the fourth region to fourth intensity,
information for setting the energy radiated by the irradiation portion in formation of the fifth region to fifth intensity lower than the fourth intensity, and
information for setting the energy radiated by the irradiation portion in formation of the sixth region to sixth intensity lower than the fifth intensity.

9. The information processing apparatus according to claim 8, wherein the fifth intensity is higher than the second intensity.

10. The information processing apparatus according to claim 8, wherein the sixth intensity is equal to the second intensity.

11. The information processing apparatus according to claim 4, wherein the fourth intensity is equal to the first intensity.

12. The information processing apparatus according to claim 1,
wherein the energy radiated by the irradiation portion is light, and
wherein the first intensity and the second intensity are each intensity of the light.

13. The information processing apparatus according to claim 1,
wherein the irradiation portion includes a light source and a liquid crystal display capable of adjusting intensity of transmitted light for each pixel, and
wherein the setting information includes a grayscale image to be displayed on the liquid crystal display.

14. The information processing apparatus according to claim 13, wherein in the grayscale image, a gradation value of a region corresponding to the shaped object is set to be within a range of 2/3 to 1 in terms of a ratio of the gradation value to a maximum gradation value.

15. A shaping system comprising:
the information processing apparatus according to claim 1; and
the shaping apparatus.

16. The shaping system according to claim 15, wherein the shaping apparatus includes the irradiation portion configured to radiate light as the energy.

17. The shaping system according to claim 16, wherein the irradiation portion includes a light source and a liquid crystal display capable of adjusting intensity of transmitted light for each pixel.

18. An information processing method for an information processing apparatus used for a shaping apparatus configured to form a shaped object including a plurality of layers laminated on each other, the information processing method comprising:
obtaining setting information set for the shaping apparatus for causing the shaping apparatus to form the plurality of layers,
wherein the plurality of layers include an (n−1)-th layer (n is an integer of 2 or more), and an n-th layer formed subsequently to the (n−1)-th layer,
wherein the n-th layer includes a first region overlapping with the (n−1)-th layer in a lamination direction, and a second region that is continuous with the first region and that does not overlap with the (n−1)-th layer in the lamination direction, and
wherein the setting information includes
information for setting an energy radiated by an irradiation portion of the shaping apparatus in formation of the first region to first intensity, and
information for setting the energy radiated by the irradiation portion in formation of the second region to second intensity lower than the first intensity.

19. A method for manufacturing a shaped object, the method comprising manufacturing the shaped object by the shaping system according to claim 15.

20. A non-transitory computer-readable recording medium storing a program for causing a computer to execute the information processing method according to claim 18.
